(19) United States
(12) Patent Application Publication
(10) Pub. No.: US 2026/0097540 A1
(43) Pub. Date: Apr. 9, 2026

(54) METHOD FOR DRY-FORMING A CELLULOSE PRODUCT AND PRODUCT FORMING UNIT FOR DRY-FORMING A CELLULOSE PRODUCT

(71) Applicant: PULPAC AB, Västra Frölunda (SE)

(72) Inventors: Peter EKWALL, Lerum (SE); Ove LARSSON, Västra Frölunda (SE)

(21) Appl. No.: 19/115,650

(22) PCT Filed: Sep. 25, 2023
(86) PCT No.: PCT/EP2023/076427

§ 371 Date: Mar. 26, 2025

(30) Foreign Application Priority Data
Sep. 27, 2022 (SE) 2251115-8
Dec. 15, 2022 (SE) 2251469-9
Dec. 15, 2022 (SE) 2251470-7
Jun. 12, 2023 (SE) 2350710-6

(51) Int. Cl. B27N 5/02

(52) U.S. Cl. CPC B27N 5/02

(57) ABSTRACT

A method for dry-forming a cellulose product from cellulose fibres in a product forming unit is disclosed. The method includes opening the forming mould and arranging cellulose fibres into the forming mould; closing the forming mould around the cellulose fibres, and after closing the forming mould, upper mould parts of the forming mould are moved towards each other in a lateral direction, and the lower mould parts are moved towards each other in the lateral direction and in a longitudinal direction towards a flexible membrane; inflating the flexible membrane with a pressure medium and applying a forming pressure onto the cellulose fibres by pressing the cellulose fibres against the upper mould parts and lower mould parts by the inflated flexible membrane, and applying a forming temperature onto the cellulose fibres, for dry-forming the cellulose product with a three-dimensional compressed fibre structure having a closed bottom portion and an upper portion.

### TECHNICAL FIELD

The present disclosure relates to a method for dry-forming a cellulose product from cellulose fibres in a product forming unit comprising a forming mould. The disclosure further relates to a product forming unit comprising a forming mould for dry-forming a cellulose product from cellulose fibres.

### BACKGROUND

Cellulose fibres are commonly used as raw material for producing or manufacturing cellulose products. Products formed of cellulose fibres can be used in many different situations where there is a need for sustainable products. A wide range of products can be produced from cellulose fibres and one specific product category relates to cellulose products having a closed bottom portion, such as for example bottles, cups, and containers with a bottom portion.

Product forming units are used when manufacturing cellulose products from raw materials including cellulose fibres, and traditionally cellulose products have been produced by wet-forming methods. A material commonly used for wet-forming cellulose fibre products is wet moulded pulp. Wet-formed products are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming methods, there is a need for drying of the wet moulded product, where the drying process is a time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products, is dry-forming of cellulose products without using wet-forming methods. Instead of forming the cellulose products from a liquid or semi liquid pulp suspension or slurry, cellulose fibres or a cellulose blank structure air-formed from cellulose fibres is used. The cellulose fibres or the cellulose blank structure is inserted into a forming mould and during the dry-forming of the cellulose products, the cellulose fibres are subjected to a high forming pressure and a high forming temperature. One difficulty with dry-forming methods is the problem with an efficient production process, where cellulose products having a closed bottom portion can be produced at high speeds with high quality, especially when forming deep drawn products.

### SUMMARY

An object of the present disclosure is to provide a method for dry-forming a cellulose product from cellulose fibres in a product forming unit comprising a forming mould, and a product forming unit for dry-forming a cellulose product comprising a forming mould, where the previously mentioned problems are avoided. This object is at least partly achieved by the features of the independent claims. The dependent claims contain further developments of the method for dry-forming a cellulose product, and the product forming unit.

The disclosure concerns a method for dry-forming a cellulose product from cellulose fibres in a product forming unit comprising a forming mould. The forming mould comprises upper mould parts and lower mould parts forming a forming cavity. A flexible membrane connected to and arranged in fluid communication with a pressure lance is arranged in the forming cavity. The method comprises the steps: opening the forming mould and arranging cellulose fibres into the open forming mould; closing the forming mould around the cellulose fibres, where upon closing of the forming mould, the upper mould parts are moved towards each other in a lateral direction, and the lower mould parts are moved towards each other in the lateral direction and in a longitudinal direction towards the flexible membrane; inflating the flexible membrane with a pressure medium entering from the pressure lance and applying a forming pressure onto the cellulose fibres by pressing the cellulose fibres against the upper mould parts and lower mould parts by means of the inflated flexible membrane, and applying a forming temperature onto the cellulose fibres, for dry-forming the cellulose product with a three-dimensional compressed fibre structure having a closed bottom portion and an upper portion.

Advantages with these features are that the method is enabling an efficient production process, where cellulose products having a closed bottom portion can be produced at high speeds with high quality and finish. The handling of the cellulose fibres is simplified through the use of the movable mould parts in combination with the flexible membrane. The product forming unit can be made more efficient, especially when forming deep drawn products. The flexible membrane is when inflated by the pressure medium applying the forming pressure onto the cellulose fibres. Further, the forming pressure together with the forming temperature applied onto cellulose fibres are efficiently forming the closed bottom portion and the upper portion of the cellulose product.

In one embodiment, the lower mould parts are movably connected to the upper mould parts and configured for being displaced relative to the upper mould parts in the longitudinal direction. The method further comprises the steps: moving the upper mould parts towards each other together with moving the lower mould parts towards each other in the lateral direction, and moving the lower mould parts relative to the upper mould parts in the longitudinal direction towards the flexible membrane upon closing of the forming mould. This is securing an efficient closing operation of the forming mould.

In one embodiment, upon closing the forming mould, the lower mould parts are first moved towards each other in the lateral direction and thereafter in the longitudinal direction towards the flexible membrane. In an alternative embodiment, upon closing the forming mould, the lower mould parts are simultaneously moved towards each other in the lateral direction and in the longitudinal direction towards the flexible membrane.

In one embodiment, the method further comprises the step: pushing the cellulose fibres towards a closed bottom configuration by means of the lower mould parts when moved in the lateral direction and the longitudinal direction upon closing the forming mould, for pre-shaping the closed bottom portion by the forces exerted by the lower mould parts. The lower mould parts are thus upon movement when closing the forming mould efficiently pre-shaping the closed bottom portion.

In one embodiment, the method further comprises the steps: partly inflating the flexible membrane with the pressure medium before movement or upon movement of the lower mould parts in the longitudinal direction towards the flexible membrane, where the partly inflated flexible membrane is pushing the cellulose fibres towards the lower mould parts and/or where the lower mould parts are pushing the cellulose fibres towards the partly inflated flexible membrane; and thereafter when the forming mould is closed around the cellulose fibres fully inflating the flexible membrane with the pressure medium for applying the forming pressure onto the cellulose fibres. The partly inflated flexible membrane is enabling an efficient distribution of the cellulose fibres in the forming cavity upon movement of the mould parts, and the fully inflated flexible membrane is establishing the forming pressure for an efficient dry-forming operation of the cellulose product in the forming mould.

In one embodiment, the method further comprises the steps: deflating the flexible membrane and opening the forming mould after forming of the cellulose product; wherein upon opening the forming mould, the upper mould parts are moved away from each other in the lateral direction, and the lower mould parts are moved away from each other in the lateral direction and in the longitudinal direction away from the flexible membrane. After the forming operation, the cellulose product can be easily removed from the forming mould by the deflation of the flexible membrane and the displacement of the mould parts.

In one embodiment, the lower mould parts are movably connected to the upper mould parts and configured for being displaced relative to the upper mould parts in the longitudinal direction. The method further comprises the steps: moving the upper mould parts away from each other together with moving the lower mould parts away from each other in the lateral direction, and moving the lower mould parts relative to the upper mould parts in the longitudinal direction away from the flexible membrane upon opening of the forming mould. This configuration is enabling a simple construction and an efficient displacement of the lower mould parts relative to the upper mould parts.

In one embodiment, upon opening the forming mould, the lower mould parts are first moved in the longitudinal direction away from the flexible membrane and thereafter away from each other in the lateral direction. In an alternative embodiment, upon opening the forming mould, the lower mould parts are simultaneously moved away from each other in the lateral direction and in the longitudinal direction away from the flexible membrane.

In one embodiment, the method further comprises the steps: air-forming the cellulose fibres into a cellulose blank structure and shaping the air-formed cellulose blank structure into a shaped cellulose blank structure having a tube-like configuration upstream the forming mould, where when arranging the cellulose fibres into the open forming mould, the shaped cellulose blank structure is fed around the pressure lance and flexible membrane into the forming mould in the longitudinal direction, and where the feeding of the shaped cellulose blank structure is stopped when positioned in the open forming mould. The shaped cellulose blank structure is used for an efficient and fast transportation of the cellulose fibres into the forming mould. The shaped cellulose blank structure is further enabling an efficient positioning of the cellulose fibres in the forming mould.

In one embodiment, the dry-formed cellulose product comprises a neck portion, where the upper portion is arranged between the closed bottom portion and the neck portion. The upper portion is arranged in fluid communication with the neck portion. The method further comprises the steps: feeding a first section of the shaped cellulose blank structure to a pre-forming mould upstream the forming mould and forming a semi-closed bottom portion of the cellulose product from the first section in the pre-forming mould, simultaneously with forming the neck portion of a directly preceding cellulose product from the first section in the pre-forming mould; feeding a following second section of the shaped cellulose blank structure to the pre-forming mould and forming the neck portion of the cellulose product from the second section in the pre-forming mould, simultaneously with forming a semi-closed bottom portion of a directly following cellulose product from the second section in the pre-forming mould. The method is enabling an efficient production process, where cellulose products with high quality can be produced at high speeds. The handling of the air-formed cellulose blank structure is simplified through use of the shaped cellulose blank structure having the tube-like configuration, and the pre-forming mould is used for efficiently producing cellulose products with high finish at increased production rates. In this way, a more efficient product forming method for producing high-quality cellulose products is achieved. The simultaneous forming of the semi-closed bottom portion of the cellulose product and the neck portion of a directly preceding cellulose product is providing a unique and fast forming operation.

In one embodiment, the pre-forming mould comprises openable and closable mould parts arranged around the pressure lance. A forming cavity is formed between the mould parts and the pressure lance. The forming of the semi-closed bottom portion of the cellulose product in the pre-forming mould further comprises the steps: opening the mould parts; feeding the shaped cellulose blank structure around the pressure lance and through the mould parts; stopping the feeding of the shaped cellulose blank structure when the first section of the shaped cellulose blank structure is arranged in a position aligned with the mould parts; closing the mould parts and pressing the first section against the pressure lance by means of the mould parts for forming the semi-closed bottom portion of the cellulose product in the forming cavity, and simultaneously forming the neck portion of the directly preceding cellulose product in the forming cavity. In this way, a section of the pressure lance is extending through the forming cavity of the pre-forming mould and the pressure lance is forming part of the pre-forming mould. The section of the pressure lance extending through the forming cavity is together with the mould parts used for an efficient forming of the neck portion and the semi-closed bottom portion in the forming cavity. During the pressing operation, a forming pressure and a forming temperature are suitably applied onto the shaped cellulose blank structure in the forming cavity, for an efficient forming operation in the pre-forming mould.

In one embodiment, the forming of the neck portion of the cellulose product in the pre-forming mould further comprises the steps: opening the mould parts; feeding the shaped cellulose blank structure around the pressure lance and through the mould parts; stopping the feeding of the shaped cellulose blank structure when the second section of the shaped cellulose blank structure is arranged in a position aligned with the mould parts; closing the mould parts and pressing the second section against the pressure lance by means of the mould parts for forming the neck portion of the cellulose product in the forming cavity, and simultaneously forming the semi-closed bottom portion of the directly following cellulose product in the forming cavity. The simultaneous forming of the semi-closed bottom portion of the cellulose product and the neck portion of a directly preceding cellulose product is providing a unique and fast forming operation, and in this way, the semi-closed bottom portion of the cellulose product is efficiently formed.

In one embodiment, the forming of the neck portion of the cellulose product in the pre-forming mould further comprises the steps: applying a forming pressure and a forming temperature onto a part of the second section of the shaped cellulose blank structure for forming a structurally rigid neck portion. In this way, the neck portion of the cellulose product is efficiently formed with a rigid structure for high structural strength and durability through the application of the forming pressure and the forming temperature onto the part of the second section used for forming the neck portion.

In one embodiment, the method further comprises the steps: feeding the formed semi-closed bottom portion of the cellulose product and an intermediate section of the shaped cellulose blank structure between the formed semi-closed bottom portion of the cellulose product and the formed neck portion of the cellulose product to the forming mould; forming the upper portion of the cellulose product from the intermediate section and forming the closed bottom portion of the cellulose product from the semi-closed bottom portion in the forming mould. The forming mould is in this way used for an efficient forming of the upper portion of the cellulose product from the intermediate section and forming the closed bottom portion of the cellulose product from the semi-closed bottom portion after the forming operations in the pre-forming mould. The flexible membrane when inflated by the pressure medium is applying the forming pressure onto the intermediate section and the semi-closed bottom portion. Further, the applied forming pressure together with the applied forming temperature onto the semi-closed bottom portion and the intermediate section are efficiently forming the closed bottom portion and the upper portion of the cellulose product.

In one embodiment, the product forming unit comprises a transporting device configured for feeding the formed semi-closed bottom portion and the intermediate section into the forming mould. The method further comprises the steps: engaging the semi-closed bottom portion and pulling the formed semi-closed bottom portion and the intermediate section into the forming mould by means of the transporting device. The transporting device is enabling an efficient feeding operation.

In one embodiment, upon forming of the semi-closed bottom portion in the pre-forming mould, a collar section of the semi-closed bottom portion is established by forces acting on the shaped cellulose blank structure. The method further comprises the step: pushing the semi-closed bottom portion towards a closed configuration upon closing the lower mould parts of the forming mould around the semi-closed bottom portion, where a collar opening of the semi-closed bottom portion is closed by the forces exerted by the lower mould parts. The closed configuration of the semi-closed bottom portion is enabling an efficient forming of the cellulose product, where the semi-closed bottom portion can be formed into the fully closed bottom portion in the forming mould upon application of the forming pressure and forming temperature.

In one embodiment, the product forming unit further comprises a cutting device arranged in the upper mould parts of the forming mould or in connection to the upper mould parts of the forming mould. The method further comprises the step: cutting off the formed neck portion of the cellulose product from the semi-closed bottom portion of the directly following cellulose product by means of the cutting device during the forming of the cellulose product in the forming mould. The cutting device may be arranged with cutting edges on the upper mould parts for an efficient cutting operation, where the cutting edges are cutting off the formed neck portion of the cellulose product from the semi-closed bottom portion of the directly following cellulose product upon closing of the forming mould. According to one example embodiment, where the pressure lance extends into the forming mould, the cutting device may be arranged to work against and around the pressure lance such that the pressure lance acts as an anvil against which the cutting edges are pressed for separating the neck portion from the semi-closed bottom portion. Here, the pressure lance may comprise a reinforced portion that can withstand the pressure from the cutting edges. The reinforced portion can be arranged as a thicker material portion of the pressure lance and/or can be made from a different material than adjacent pressure lance portions. As an alternative, the entire pressure lance is made from a suitable material than can withstand pressure both in the forming mould and in the pre-forming mould.

In one embodiment, the pre-forming mould comprises a thread forming section. The method further comprises the step: forming a threaded section of the neck portion upon forming of the neck portion in the pre-forming mould by means of the thread forming section. The thread forming section comprises a threaded pattern enabling efficient forming of the threaded section of the neck portion in the pre-forming mould.

The disclosure further concerns a product forming unit for dry-forming a cellulose product from cellulose fibres. The product forming unit comprises a forming mould having upper mould parts and lower mould parts forming a forming cavity. A flexible membrane connected to and arranged in fluid communication with a pressure lance is arranged in the forming cavity. The forming mould is configured for being closed around the cellulose fibres. Upon closing of the forming mould, the upper mould parts are moved towards each other in a lateral direction, and the lower mould parts are moved towards each other in the lateral direction and in a longitudinal direction towards the flexible membrane. The flexible membrane is configured for being inflated with a pressure medium entering from the pressure lance for applying a forming pressure onto the cellulose fibres by pressing the cellulose fibres against the upper mould parts and lower mould parts by means of the inflated flexible membrane, and the forming mould is configured for applying a forming temperature onto the cellulose fibres, for dry-forming the cellulose product with a three-dimensional compressed fibre structure having a closed bottom portion and an upper portion. Advantages with these features are that the product forming unit is enabling an efficient production process, where cellulose products having a closed bottom portion can be produced at high speeds with high quality and finish. The handling of the cellulose fibres is simplified through the use of the movable mould parts in combination with the flexible membrane. The product forming unit can be made more efficient, especially when forming deep drawn products. The flexible membrane is when inflated by the pressure medium applying the forming pressure onto the cellulose fibres. Further, the forming pressure together with the forming temperature applied onto cellulose fibres are efficiently forming the closed bottom portion and the upper portion of the cellulose product.

In one embodiment, the lower mould parts are movably connected to the upper mould parts and configured for being displaced relative to the upper mould parts in the longitudinal direction. This configuration is enabling a simple construction and an efficient displacement of the lower mould parts relative to the upper mould parts.

In one embodiment, the product forming unit is configured for partly inflating the flexible membrane with the pressure medium before movement or upon movement of the lower mould parts in the longitudinal direction towards the flexible membrane. The partly inflated flexible membrane is configured for pushing the cellulose fibres towards the lower mould parts and/or the lower mould parts are configured for pushing the cellulose fibres towards the partly inflated flexible membrane. The partly inflated flexible membrane is enabling an efficient distribution of the cellulose fibres in the forming cavity upon movement of the mould parts, before the fully inflated flexible membrane is establishing the forming pressure for an efficient dry-forming operation of the cellulose product in the forming mould.

In one embodiment, the forming mould is configured for being opened after forming of the cellulose product. Upon opening the forming mould, the upper mould parts are moved away from each other in the lateral direction, and the lower mould parts are moved away from each other in the lateral direction and in the longitudinal direction away from the flexible membrane.

In one embodiment, the pressure lance is extending to or partly into the forming cavity. The pressure lance is with these configurations efficiently providing the pressure medium to the flexible membrane arranged within the forming cavity of the forming mould for inflating or deflating the flexible membrane in the forming operation process.

In one embodiment, the product forming unit comprises a shaping unit and a feeding unit. The shaping unit is configured for shaping a cellulose blank structure air-formed from the cellulose fibres into a shaped cellulose blank structure having a tube-like configuration upstream the forming mould. The feeding unit is configured for feeding the shaped cellulose blank structure in the longitudinal direction around the pressure lance and flexible membrane into the forming mould when arranging the cellulose fibres into the open forming mould. The shaping unit is thus shaping the cellulose blank structure into a shaped cellulose blank structure for an efficient handling and feeding of the cellulose blank structure to the forming mould. The feeding unit is efficiently feeding the shaped cellulose blank structure around the pressure lance and flexible membrane into the forming mould when the upper mould parts and the lower mould parts are open. The shaped cellulose blank structure is further enabling an efficient positioning of the cellulose fibres in the forming mould.

In one embodiment, the product forming unit is configured for dry-forming the cellulose product from the air-formed cellulose blank structure. The dry-formed cellulose product comprises a neck portion, where the upper portion is arranged between the closed bottom portion and the neck portion. The upper portion is arranged in fluid communication with the neck portion. The feeding unit is configured for feeding the shaped cellulose blank structure to a pre-forming mould upstream the forming mould, where the pre-forming mould is configured for forming a neck portion of a leading cellulose product simultaneously with forming a semi-closed bottom portion of a directly following trailing cellulose product from the shaped cellulose blank structure. The product forming unit is enabling an efficient production process, where cellulose products with high quality can be produced at high speeds. The handling of the air-formed cellulose blank structure is simplified through use of the shaped cellulose blank structure having the tube-like configuration, and the pre-forming mould is used for efficiently producing cellulose products with high finish at increased production rates. In this way, a more efficient forming unit for producing high-quality cellulose products is achieved. The simultaneous forming of the semi-closed bottom portion of the cellulose product and the neck portion of a directly preceding cellulose product from the shaped cellulose blank structure is providing a unique and fast forming operation.

In one embodiment, the pre-forming mould comprises openable and closable mould parts arranged around the pressure lance. A forming cavity is formed between the mould parts and the pressure lance, and the feeding unit is configured for feeding the shaped cellulose blank structure around the pressure lance and through the mould parts when the mould parts are open. The mould parts are when closed configured for pressing the shaped cellulose blank structure against the pressure lance for simultaneously forming the neck portion and the semi-closed bottom portion in the forming cavity. In this way, a section of the pressure lance extending through the forming cavity is forming part of the pre-forming mould, and the section of the pressure lance is used for an efficient forming of the neck portion and the semi-closed bottom portion in the forming cavity. During the pressing operation, a forming pressure and a forming temperature are applied onto a part of the shaped cellulose blank structure used for forming the neck portion in the forming cavity, for an efficient forming operation in the pre-forming mould.

In one embodiment, the mould parts of the pre-forming mould comprises a thread forming section configured for forming a threaded section of the neck portion upon forming of the neck portion in the pre-forming mould. The thread forming section comprises a threaded pattern for efficient forming of the threaded section of the neck portion in the pre-forming mould.

In one embodiment, the feeding unit is configured for feeding a formed semi-closed bottom portion and an intermediate section of the shaped cellulose blank structure between the formed semi-closed bottom portion and a directly following formed trailing neck portion to the forming mould. The forming mould is configured for forming the upper portion from the intermediate section and forming the closed bottom portion from the semi-closed bottom portion. The forming mould is in this way used for an efficient forming of the upper portion of the cellulose product from the intermediate section and forming the closed bottom portion of the cellulose product from the semi-closed bottom portion after the forming and shaping operations in the pre-forming mould. The mould parts of the forming mould together with the flexible membrane, when the mould parts are closed around the shaped cellulose blank structure, are forming the upper portion and the closed bottom portion by inflating the flexible membrane with the pressure medium entering from the pressure lance, where the semi-closed bottom portion and the intermediate section are pressed against the upper mould parts and lower mould parts by means of the inflated flexible membrane. Further, the applied forming pressure together with the applied second forming temperature onto the semi-closed bottom portion and the intermediate section are efficiently forming the closed bottom portion and the upper portion of the cellulose product.

In one embodiment, the feeding unit comprises a transporting device configured for feeding the formed semi-closed bottom portion and the intermediate section into the forming mould. The transporting device is configured for engaging the semi-closed bottom portion and pulling the formed semi-closed bottom portion and the intermediate section into the forming mould. The transporting device is used for an efficient feeding operation.

In one embodiment, the product forming unit further comprises a cutting device arranged in the upper mould parts or in connection to the upper mould parts. The cutting device is configured for cutting off the formed neck portion of a leading cellulose product from the semi-closed bottom portion of a directly following trailing cellulose product by means of the cutting device during the forming of the cellulose product in the forming mould. The cutting device may be arranged with cutting edges on the upper mould parts for an efficient cutting operation, where the cutting edges are cutting off the formed neck portion of the leading cellulose product from the semi-closed bottom portion of the directly following trailing cellulose product upon closing of the forming mould.

In one embodiment, the product forming unit comprises a fluid control device. The pressure lance is at a first end arranged in fluid communication with the fluid control device, and the pressure lance is at a second end arranged in fluid communication with the flexible membrane. The fluid control device is configured for inflating the flexible membrane with the pressure medium via the pressure lance. The fluid control device is further arranged for deflating the flexible membrane via the pressure lance after the forming operation in the forming mould. The fluid control device may have any suitable configuration, and may comprise hydraulic or pneumatic cylinders, fluid pumps, compressors, or other pressure establishing devices for delivering pressurized pressure medium to the flexible membrane via the pressure lance.

### BRIEF DESCRIPTION OF DRAWINGS

The disclosure will be described in detail in the following, with reference to the attached drawings, in which

FIG. 1a-h show schematically, in side views, a product forming unit comprising a forming mould for dry-forming a cellulose product from cellulose fibres, in different forming steps,

FIG. 2 shows schematically, in a perspective view, an embodiment of an alternative product forming unit with a pre-forming mould and a forming mould,

FIG. 3a-f show schematically, in a perspective view from above and a perspective view from below, a cellulose product formed in the alternative product forming unit; and in side views and in a perspective view, a shaped cellulose blank structure in different forming steps,

FIG. 4a-e show schematically, in perspective views from above, the pre-forming mould of the alternative product forming unit in different operational steps,

FIG. 5a-f show schematically, in side views, the forming mould of the alternative product forming unit in different operational steps,

FIG. 6a-f show schematically, in perspective views, the alternative product forming unit with the pre-forming mould and the forming mould in different operational steps,

FIG. 7 shows schematically in a perspective view a transporting unit for transportation of formed cellulose products away from the forming mould of the alternative product forming unit, and

FIG. 8a-e show schematically, in side views, an embodiment of a further alternative product forming unit with a transporting device.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

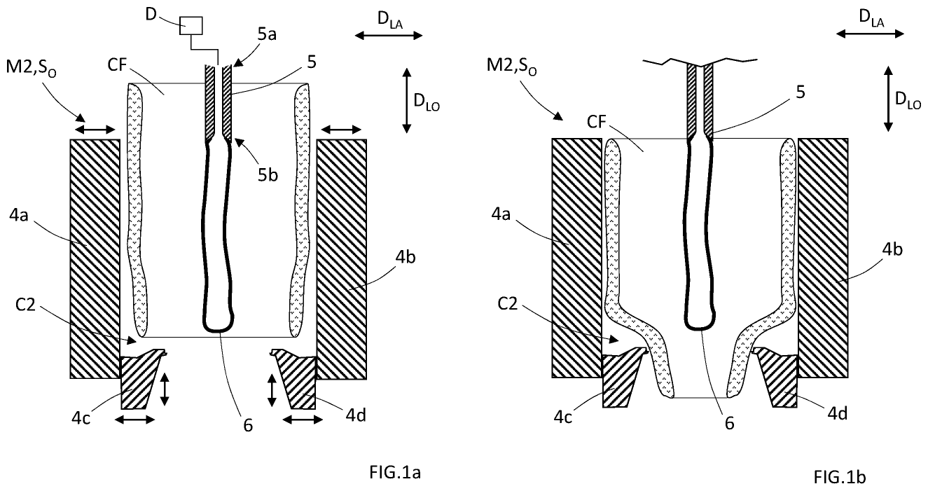

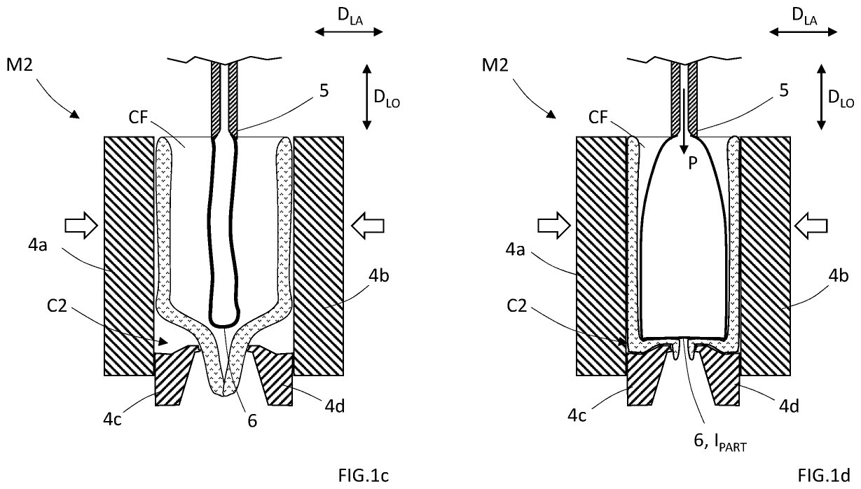

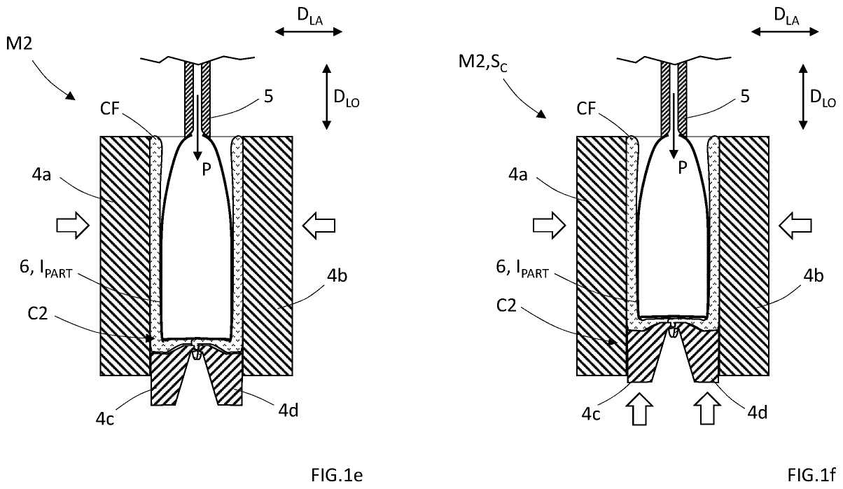

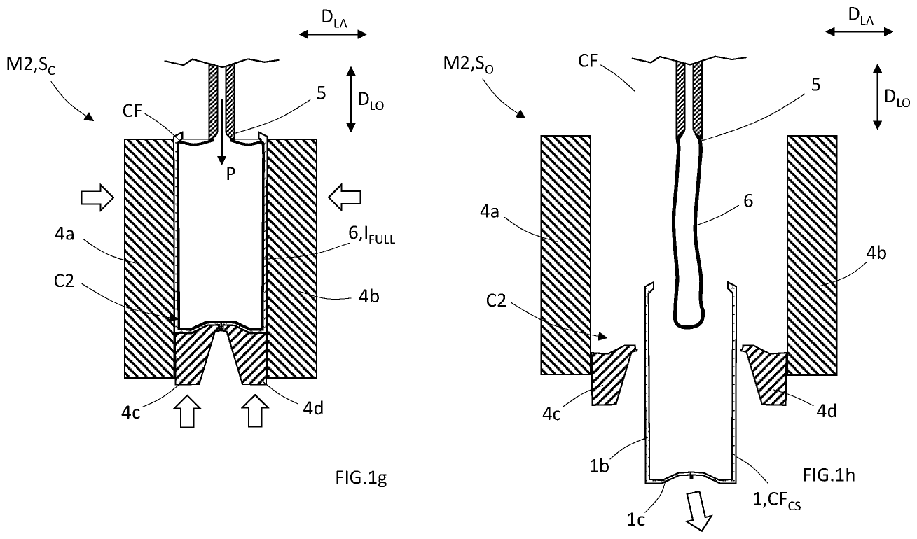

FIGS. 1a-h schematically show a first embodiment of a product forming unit U for dry-forming a cellulose product 1 from cellulose fibres CF. The product forming unit U comprises a forming mould M2 having an extension in a longitudinal direction D_{LO} and a lateral direction D_{LA}. The product forming unit U is arranged for dry-forming the cellulose product 1 from the cellulose fibres CF in different operational steps in the forming mould M2 for an efficient product forming process. The forming mould M2 comprises openable and closable upper mould parts 4a,4b and lower mould parts 4c,4d forming a forming cavity C2. A flexible membrane 6 connected to and arranged in fluid communication with a pressure lance 5 is arranged in the forming cavity C2. The pressure lance 5 is suitably extending to or partly into the forming cavity C2. A pressure medium P is used for inflating the flexible membrane 6 when dry-forming the cellulose products 1. The forming mould M2 comprises in this embodiment two upper mould parts 4a, 4b and two lower mould parts 4c,4d.

A first upper mould part 4a and a second upper mould part 4b are movably arranged relative to each other and relative to the flexible membrane 6 in the lateral direction D_{LA}, as indicated with the double arrows in FIG. 1a. A first lower mould part 4c and a second lower mould part 4d are movably arranged relative to each other in the lateral direction D_{LA} and movably arranged in the longitudinal direction D_{LO} towards the flexible membrane 6, as indicated with the double arrows in FIG. 1a. The first lower mould part 4c may suitably be movably connected to the first upper mould part 4a, and the second lower mould part 4d may suitably be movably connected to the second upper mould part 4b. The lower mould parts 4c,4d are in this way configured for being displaced relative to the corresponding upper mould parts 4a,4b in the longitudinal direction D_{LO}.

The first upper mould part 4a is suitably displaceable in the lateral direction D_{LA} in reciprocating linear movements towards and away from the second upper mould part 4b and the flexible membrane 6. The second upper mould part 4b is suitably displaceable in the lateral direction D_{LA} in reciprocating linear movements towards and away from the first upper mould part 4a and the flexible membrane 6. The first lower mould part 4c is suitably displaceable in the lateral direction D_{LA} in reciprocating linear movements towards and away from the second lower mould part 4d. The second lower mould part 4d is suitably displaceable in the lateral direction D_{LA} in reciprocating linear movements towards and away from the first lower mould part 4c. The first lower mould part 4c is suitably displaceable in the longitudinal direction D_{LO} in reciprocating linear movements towards and away from the flexible membrane 6. The second lower mould part 4d is suitably displaceable in the longitudinal direction D_{LO} in reciprocating linear movements towards and away from the flexible membrane 6. Suitable actuating means are used for displacing the mould parts.

When closing the forming mould M2, the upper mould parts 4a,4b are moved towards each other together with moving the lower mould parts 4c, 4d towards each other in the lateral direction D_{LA}, and the lower mould parts 4c,4d are moved relative to the respective upper mould parts 4a,4b in the longitudinal direction D_{LO} towards the flexible membrane 6.

It should be understood that the expressions moved towards each other or displaced towards each other, with respect to the mould parts, could also include a forming mould configuration where one mould part is stationary and the other mould part is movably arranged and moved or displaced towards the stationary mould part. When one mould part is stationary, suitably the pressure lance 5 is movably arranged relative to the mould parts, to enable and simplify the feeding of cellulose fibres CF into the forming mould M2, and removal of the formed cellulose product 1 from the forming mould M2.

When opening the forming mould M2, the upper mould parts 4a,4b are moved away from each other together with moving the lower mould parts 4c, 4d away from each other in the lateral direction D_{LA}, and the lower mould parts 4c,4d are moved relative to the respective upper mould parts 4a,4b in the longitudinal direction D_{LO} away from the flexible membrane 6.

It should be understood that the expressions moved away from each other or displaced away from each other, with respect to the mould parts, could also include a forming mould configuration where one mould part is stationary and the other mould part is movably arranged and moved or displaced away from the stationary mould part.

In FIG. 1a, the forming mould M2 is arranged in an open state S_{O}, where the upper mould parts 4a,4b have been displaced in the lateral direction D_{LA} away from each other and away from the flexible membrane 6, and the lower mould parts 4c,4d have been displaced in the lateral direction D_{LA} and the longitudinal direction D_{LO} away from each other and away from the flexible membrane 6. In the open state S_{O}, the cellulose fibres CF are fed around the flexible membrane 6 and received between the upper mould parts 4a,4b and lower mould parts 4c,4d, as shown in FIGS. 1a-b. The cellulose fibres CF may be fed into the forming mould M2 with any suitable feeding or transporting means. The cellulose fibres CF may suitably be air-formed into a body of cellulose fibres CF, such as a shaped cellulose blank structure, before being fed to the forming mould M2, as schematically shown in FIGS. 1a-b. The air-formed cellulose fibres CF may be arranged into the forming mould M2 with any suitable transportation means, and as shown in FIG. 1b, the lower section of the body of cellulose fibres CF are shaped during the feeding operation past the lower mould parts 4c,4d. In other embodiments, the cellulose fibres may be sprayed or sprinkled directly into the forming mould M2.

In the forming cavity C2 of the forming mould M2, the cellulose product 1 is dry-formed from the cellulose fibres CF into a three-dimensional compressed fibre structure CF_{CS} having an upper portion 1b and a closed bottom portion 1c, as shown in FIG. 1h.

When the cellulose fibres CF have been arranged in the open forming mould M2, as shown in FIGS. 1a-b, the forming mould M2 is closed around the cellulose fibres CF. Upon closing of the forming mould M2, the upper mould parts 4a,4b are moved towards each other in the lateral direction D_{LA}, and the lower mould parts 4c,4d are moved towards each other in the lateral direction D_{LA} and in the longitudinal direction D_{LO} towards the flexible membrane 6, as will be further described below in connection to FIGS. 1c-f.

In FIG. 1b, the body of cellulose fibres CF has been positioned between the upper mould parts 4a,4b and the lower mould parts 4c,4d respectively, with the flexible membrane 6 arranged inside the body of cellulose fibres CF. Thereafter, the forming mould M2 is displaced from the open state S_{O} to a closed state Sc. As shown in FIGS. 1c-e, the upper mould parts 4a,4b are moved towards each other in the lateral direction D_{LA} as indicated with the arrows, together with moving the lower mould parts 4c, 4d towards each other in the lateral direction D_{LA}. The lower mould parts 4c,4d are thus displaced together with upper mould parts 4a,4b in the lateral direction D_{LA}, and the forming mould M2 is arranged with suitable actuating means, such as electric motors, linear actuators, pneumatic actuators, or hydraulic actuators, for the displacement of the mould parts. When the mould parts have reached the position shown in FIG. 1e, the lower mould parts 4c,4d are moved relative to the upper mould parts 4a, 4b in the longitudinal direction D_{LO} towards the flexible membrane 6 upon closing of the forming mould M2, as shown in FIG. 1f. In FIG. 1f, the forming mould M2 is arranged in the closed state S_{C}, in which the cellulose fibres CF can be dry-formed into the cellulose product 1.

Upon movement of the mould parts in the lateral direction D_{LA} and the longitudinal direction D_{LO}, the flexible membrane 6 may be partly inflated with the pressure medium P into a partly inflated state I_{PART}, as shown in FIGS. 1d-f. In the partly inflated state I_{PART}, the partly inflated flexible membrane 6 is pushing the cellulose fibres CF towards the lower mould parts 4c,4d and/or the lower mould parts 4c,4d are pushing the cellulose fibres CF towards the partly inflated flexible membrane 6 for an efficient distribution of the cellulose fibres in the forming cavity C2. The partly inflated flexible membrane 6 is thus enabling an efficient distribution of the cellulose fibres CF in the forming cavity C2 upon movement of the mould parts, and it should be understood that the flexible membrane 6 may be partly inflated with the pressure medium P before movement or upon movement of the lower mould parts 4c,4d in the longitudinal direction D_{LO} towards the flexible membrane 6. During the closing of the forming mould M2, the cellulose fibres CF are pushed towards a closed bottom configuration by means of the lower mould parts 4c,4d when moved in the lateral direction D_{LA} and the longitudinal direction D_{LO}, for pre-shaping the closed bottom portion 1c by the forces exerted by the lower mould parts 4c,4d, as shown in FIGS. 1e-f.

When the forming mould is arranged in the closed state S_{C}, the flexible membrane 6 is further inflated into a fully inflated state I_{FULL} for establishing a forming pressure P_{F2} for an efficient dry-forming operation of the cellulose product 1 in the forming mould M2, as shown in FIG. 1g. Thus, when the forming mould M2 is closed around the cellulose fibres CF, the flexible membrane 6 is fully inflated with the pressure medium P for applying the forming pressure P_{F2} onto the cellulose fibres CF. The flexible membrane 6 is inflated with the pressure medium P entering from the pressure lance 5, and the forming pressure P_{F2} is applied onto the cellulose fibres CF by pressing the cellulose fibres CF against the upper mould parts 4a,4b and lower mould parts 4c,4d by means of the inflated flexible membrane 6. A forming temperature T_{F2} is applied onto the cellulose fibres CF in the forming mould M2. In this way the forming pressure P_{F2} and the forming temperature T_{F2} are enabling the dry-forming of the cellulose product 1 into a three-dimensional compressed fibre structure CF_{CS} having a closed bottom portion 1c and an upper portion 1b.

The applied forming pressure P_{F2} in the forming mould M2 is suitably in the range of 1-100 MPa, preferably 4-20 MPa, and the applied forming temperature T_{F2} is suitably in the range of 60-300° C., preferably 100-200° C.

After the forming operation, the forming mould M2 is returned to the open state S_{O}, as shown in FIG. 1h, for an easy removal of the cellulose product 1 from the forming mould M2 and for repeating the dry-forming operation. After forming of the cellulose product 1, the flexible membrane 6 is deflated and the forming mould M2 is opened. Upon opening the forming mould M2, the upper mould parts 4a,4b are moved away from each other in the lateral direction D_{LA}, and the lower mould parts 4c, 4d are moved away from each other in the lateral direction D_{LA} and in the longitudinal direction D_{LO} away from the flexible membrane 6, as understood from FIG. 1h. Upon opening of the forming mould M2, the lower mould parts 4c,4d may first be moved in the longitudinal direction D_{LO} away from the flexible membrane 6 and thereafter away from each other in the lateral direction D_{LA}, or the lower mould parts 4c,4d may be simultaneously moved away from each other in the lateral direction D_{LA} and in the longitudinal direction D_{LO} away from the flexible membrane 6. As described above, the lower mould parts 4c,4d may be movably connected to the upper mould parts 4a,4b and configured for being displaced relative to the upper mould parts 4a,4b in the longitudinal direction D_{LO}. With such a configuration, the upper mould parts 4a,4b are moved away from each other together with moving the lower mould parts 4c, 4d away from each other in the lateral direction D_{LA} upon opening of the forming mould M2, and the lower mould parts 4c,4d are moved relative to the upper mould parts in the longitudinal direction D_{LO} away from the flexible membrane 6 upon opening of the forming mould M2.

The upper mould parts 4a,4b and the lower mould parts 4c,4d of the forming mould M2 are suitably arranged as stiff mould parts. With stiff mould parts is meant that the mould parts are made of a stiff material with limited deformation capabilities, such as for example steel, aluminium, composite materials or a combination of different materials. The forming mould M2 may be arranged with any suitable number of upper mould parts 4a,4b and lower mould parts 4c,4d for an efficient dry-forming operation.

The second mould part M2 may further comprise a non-illustrated heating unit. The heating unit is configured for applying the second forming temperature T_{F2} onto the cellulose fibres CF during the forming operation in the forming mould M2. The heating unit may have any suitable configuration. The heating unit may be integrated in or cast into the mould parts, and suitable heating devices are e.g. electrical heaters, such as resistor elements, or fluid heaters. Other suitable heat sources may also be used.

The flexible membrane 6 is made of a material that is allowed to deform when being inflated upon dry-forming of the cellulose products 1 in the forming mould M2. Suitable materials are for elastomeric compositions, such as for example rubber, or other elastomers exhibiting elastic or rubber-like properties. The material used in the flexible membrane 6 suitably withstands high pressure levels from the pressure medium P when being inflated, as well as repeated inflation and deflation cycles.

In other non-illustrated embodiments, the flexible membrane 6 may be made of a liquid impermeable single-use plastic film or other suitable material that is adhering to the cellulose product 1 during the forming process. In this way, the plastic film or other suitable material is forming a liquid barrier inside the formed cellulose product 1. With this configuration, a new flexible membrane 6 is provided for each product forming operation in the forming mould M2.

The pressure medium P is used for establishing the second forming pressure P_{F2} in the forming cavity C2 upon inflating the flexible membrane 6. The pressure medium P used in the forming operation in the forming mould M2 may be a liquid composition or a gas, such as for example oil, water, or air. In the embodiment described above, where the flexible membrane 6 is made of a single-use plastic film or other suitable material that is adhering to the cellulose product 1 during the forming process, the pressure medium P may be a beverage or other liquid that is pressurizing the flexible membrane 6 when forming the cellulose product 1. In this way, the beverage or other liquid is directly filled into the cellulose product 1 during the forming process.

The product forming unit U suitably comprises a fluid control device D, as schematically indicated in FIG. 1a. The pressure lance 5 is at a first end 5a arranged in fluid communication with the fluid control device D, and the pressure lance 5 is at a second end 5b arranged in fluid communication with the flexible membrane 6. The fluid control device D is configured for inflating the flexible membrane 6 with the pressure medium P via the pressure lance 5 upon forming in the forming mould M2. The fluid control device D is further arranged for deflating the flexible membrane 6 via the pressure lance 5 after the forming operation in the forming mould M2. The fluid control device D may have any suitable configuration, and may comprise hydraulic or pneumatic cylinders, fluid pumps, compressors, or other pressure establishing devices for delivering pressurized pressure medium P to the flexible membrane 6 via the pressure lance 5. The product forming unit U may further comprise a control unit for controlling the forming operation.

In the embodiment described above, upon closing the forming mould M2, the lower mould parts 4c,4d are first moved towards each other in the lateral direction D_{LA} and thereafter in the longitudinal direction D_{LO} towards the flexible membrane 6. In an alternative embodiment, upon closing the forming mould M2, the lower mould parts 4c,4d are simultaneously moved towards each other in the lateral direction D_{LA} and in the longitudinal direction D_{LO} towards the flexible membrane 6.

In other non-illustrated embodiments, one of the first upper mould part 4a and the second upper mould part 4b may be arranged as a stationary mould part, where the other mould part is movably arranged.

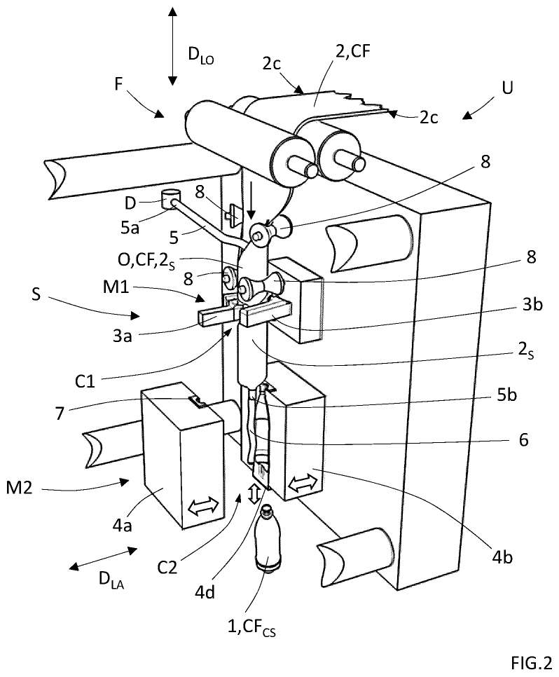

FIG. 2 schematically shows a second alternative embodiment of a product forming unit U for dry-forming a cellulose product 1 from a cellulose blank structure 2 air-formed from cellulose fibres CF. In this embodiment, the cellulose product 1 is exemplified as a cellulose bottle. The product forming unit U comprises a feeding unit F, a shaping unit S, a pre-forming mould M1, and a forming mould M2 arranged downstream the pre-forming mould M1. The product forming unit U is arranged for dry-forming the cellulose product 1 from the cellulose blank structure 2 in different operational steps in the pre-forming mould M1 and the forming mould M2 for an efficient product forming process. In the embodiment illustrated in FIG. 2, the pre-forming mould M1 is positioned above the forming mould M2, and the pre-forming mould M1 is in this way arranged upstream the forming mould M2. It should however be understood that the product forming unit U in other non-illustrated embodiments may be positioned in other ways, where the pre-forming mould M1 is arranged upstream the forming mould M2.

With an air-formed cellulose blank structure 2 is meant an essentially air-formed fibrous web structure produced from cellulose fibres CF, where the cellulose fibres CF are air-formed into the cellulose blank structure 2. The cellulose fibres CF may originate from a suitable cellulose raw material, such as a pulp material. Suitable pulp materials are for example fluff pulp, paper structures, or other cellulose fibre-containing structures. With air-forming of the cellulose blank structure 2 is meant the formation of a cellulose blank structure in a dry-forming process in which the cellulose fibres CF are air-formed to produce the cellulose blank structure 2. When air-forming the cellulose blank structure 2 in the air-forming process, the cellulose fibres CF are carried and formed to the cellulose blank structure 2 by air as carrying medium. This is different from a normal papermaking process or a traditional wet-forming process, where water is used as carrying medium for the cellulose fibres CF when forming the paper or fibre structure. In the air-forming process, small amounts of water or other substances may if desired be added to the cellulose fibres CF in order to change the properties of the cellulose products, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products 1.

The cellulose blank structure 2 may have a composition where the fibres are of the same origin or alternatively contain a mix of two or more types of cellulose fibres, depending on the desired properties of the cellulose products 1. The cellulose fibres CF used in the cellulose blank structure 2 are during the forming process of the cellulose products 1 strongly bonded to each other. The cellulose fibres CF may be mixed with other substances or compounds to a certain amount as will be further described below. With cellulose fibres CF is meant any type of cellulose fibres, such as natural cellulose fibres or manufactured cellulose fibres. The cellulose blank structure 2 may specifically comprise at least 95% cellulose fibres CF, or more specifically at least 99% cellulose fibres CF. However, the cellulose blank structure 2 may have other suitable configurations and cellulose fibre amounts.

The air-formed cellulose blank structure 2 may have a single-layer or a multi-layer configuration. A cellulose blank structure 2 having a single-layer configuration is referring to a structure that is formed of one layer containing cellulose fibres. A cellulose blank structure 2 having a multi-layer configuration is referring to a structure that is formed of two or more layers comprising cellulose fibres, where the layers may have the same or different compositions or configurations.

One or more reinforcement layers comprising cellulose fibres may be added to the cellulose blank structure 2. The one or more reinforcement layers may be arranged as carrying layers for the cellulose blank structure 2. The reinforcement layer may have a higher tensile strength than the cellulose blank structure 2. This is useful when one or more air-formed layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for the cellulose blank structure 2. The reinforcement layer may be of a different composition than the cellulose blank structure 2, such as for example a tissue layer containing cellulose fibres, an airlaid structure comprising cellulose fibres, or other suitable layer structures. It is thus not necessary that the reinforcement layer is air-formed. The one or more reinforcement layers may be provided with graphical elements or patterns for enabling aesthetically attractive cellulose products 1.

The cellulose blank structure 2 may further comprise or be arranged in connection to one or more barrier layers giving the cellulose products 1 the ability to hold or withstand liquids, such as for example when the cellulose products 1 are used in contact with beverages, food, and other water-containing substances. The one or more barrier layers may be of a different composition than the rest of the cellulose blank structure 2, such as for example a tissue barrier structure or a plastic film structure. The cellulose blank structure 2 may further comprise additives for achieving desired properties of the cellulose products 1. The one or more barrier layers may also be applied to the outside of the cellulose products 1, and the one or more barrier layers may be provided with graphical elements or patterns for enabling aesthetically attractive cellulose products 1.

The one or more air-formed layers of the cellulose blank structure 2 are fluffy and airy structures, where the cellulose fibres CF forming the structures are arranged relatively loosely in relation to each other. The fluffy cellulose blank structures 2 are used for an efficient forming of the cellulose products 1, allowing the cellulose fibres CF to form the cellulose products 1 in an efficient way during the forming process.

The shaping unit S is configured for shaping the cellulose blank structure 2 air-formed from the cellulose fibres CF into a shaped cellulose blank structure 2_{S}. This shaping of the cellulose blank structure 2 in the shaping unit S is enabling efficient transportation of the cellulose blank structure 2 and forming of the cellulose products 1 in the pre-forming mould M1 and the forming mould M2. As understood from FIG. 2, the cellulose blank structure 2 is shaped into the shaped cellulose blank structure 2_{S} upstream the pre-forming mould M1 and the forming mould M2. In the shaping unit S, the cellulose blank structure 2 is shaped into the shaped cellulose blank structure 2_{S} having a tube-like configuration with an inner surface 2a and an outer surface 2b. The cellulose blank structure 2 comprising the cellulose fibres CF is suitably provided to the product forming unit U in a flat shape, or essentially flat shape as understood from FIG. 2.

The cellulose blank structure 2 is as shown in FIG. 2 transported to the feeding unit F for further transportation of the cellulose blank structure 2 to the shaping unit S and the forming moulds, and in the illustrated embodiment, the feeding unit F comprises a pair of feeding rollers. The feeding unit F is configured for feeding the shaped cellulose blank structure 2_{S} to the pre-forming mould M1 and the forming mould M2. The feeding unit is further arranged to stop the feeding of the shaped cellulose blank structure 2_{S} upon forming in the respective forming moulds. It should however be understood that the feeding unit F may have any suitable configuration, such as conveyor belts or other transporting means. The feeding unit F may further be arranged with non-illustrated feeding rollers, feeding belts, or other transportation means arranged in connection to the pre-forming mould M1 and/or the forming mould M2, for an efficient feeding, pulling and/or pushing of the shaped cellulose blank structure 2_{S} through the product forming unit U. The feeding rollers, feeding belts, or other transportation means, may be arranged before and/or after the pre-forming mould M1 and/or the forming mould M2, and provided with suitable gripping means for feeding, pulling and/or pushing the shaped cellulose blank structure 2_{S}. The construction and layout of the feeding unit F may for example vary depending on the design of the product forming unit U, the size and design of the cellulose products 1 produced, and materials used in the cellulose blank structure 2.

In the embodiment illustrated in FIG. 2, the shaping unit S comprises a plurality of deflecting rollers 8 for shaping the air-formed cellulose blank structure 2 into the shaped cellulose blank structure 2_{S}. As exemplified, the deflecting rollers 8 are shaping the cellulose blank structure 2 upon feeding in a longitudinal direction D_{LO} of the product forming unit U through a deflecting movement of the cellulose blank structure 2 enabled by the deflecting rollers 8. When passing through the shaping unit S, the cellulose blank structure 2 is shaped into the shaped cellulose blank structure 2_{S} with the tube-like configuration by the deflecting rollers 8, as understood from FIG. 2. The formed shaped cellulose blank structure 2_{S} is suitably having an overlapping tube-like configuration O that is securing that the shaped cellulose blank structure 2_{S} is formed without any gaps or open passages. When being shaped, opposite side edges 2c of the cellulose blank structure 2 are overlapping each other in the shaped cellulose blank structure 2_{S}. The shaping unit S may in other non-illustrated embodiments be arranged with deflecting plates or similar arrangements instead of the deflecting rollers 8, or alternatively arranged with a combination of deflecting plates and deflecting rollers.

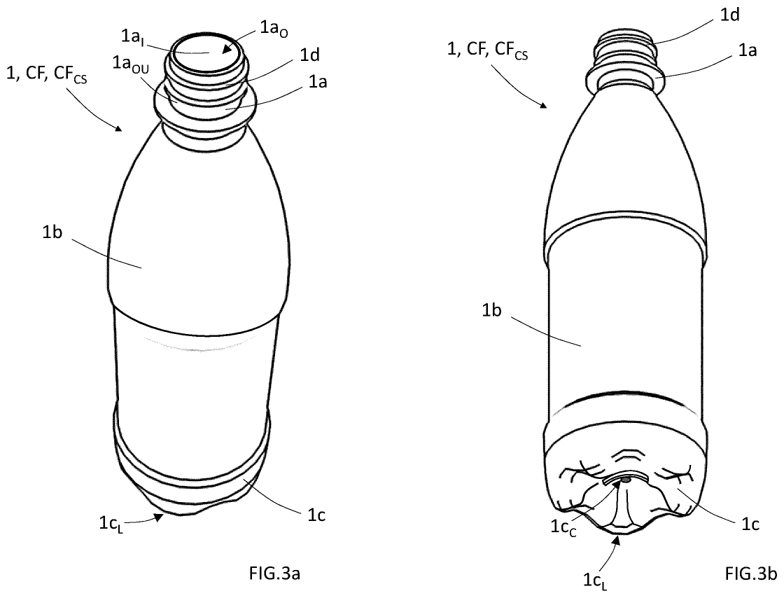

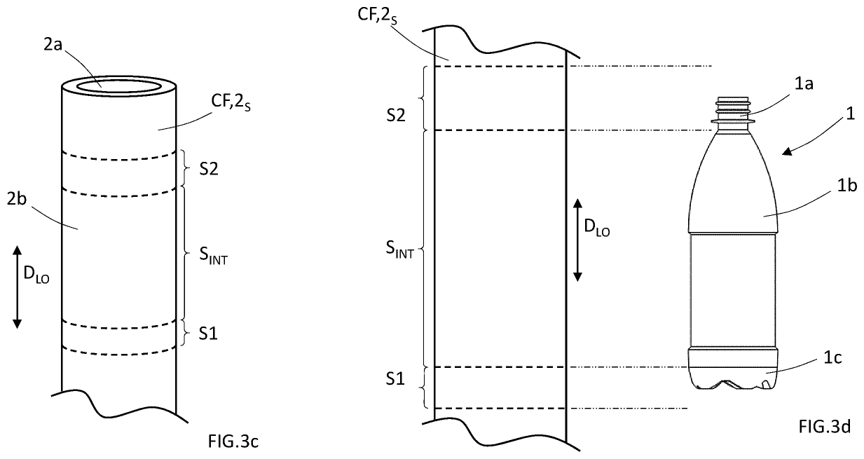

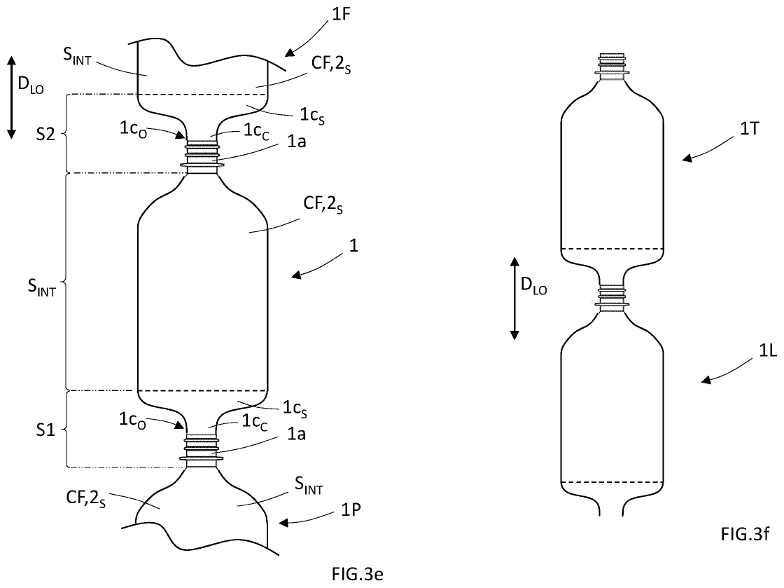

A dry-formed cellulose product 1 is schematically shown in FIGS. 3a-b. The cellulose product 1 has a longitudinal extension and comprises a neck portion 1a, a closed bottom portion 1c, and an upper portion 1b arranged in the longitudinal direction between the closed bottom portion 1c and the neck portion 1a. When the cellulose product 1 is arranged in the position shown in FIGS. 3a-b, the upper portion 1b is arranged above the closed bottom portion 1c and the neck portion 1a is arranged above the upper portion 1b. In the following, when it is referred to relative positions of the cellulose product 1 when formed or upon forming, expressions such as above are referring to the positioning of the cellulose product 1 illustrated in FIGS. 3a-b, where the cellulose product 1 is arranged for being placed on a surface in a standing position. The upper portion 1b is arranged in fluid communication with the neck portion 1a, and the neck portion 1a is provided with a flow opening 1a_{O}. The neck portion 1a suitably comprises a threaded section 1d for a secure attachment of a non-illustrated threaded cap.

The dry-formed cellulose product 1 shown in FIGS. 3a-b is arranged as a rigid self-sustained cellulose-based bottle having a three-dimensional compressed fibre structure CF_{CS}, comprising compressed air-formed cellulose fibres CF. The neck portion 1a is in a conventional manner arranged with a through channel for transportation of liquids out from the cellulose product 1 via the flow opening 1a_{O}. The closed bottom portion 1c and the upper portion 1b are together forming a liquid holding space, and the upper portion 1b has a hollow configuration.

As will be further described below, the closed bottom portion 1c comprises a centrally arranged closed collar section 1c_{C} of compressed cellulose fibres CF. The centrally closed collar section 1c_{C} is resulting from the bottle forming process in the pre-forming mould M1 and the forming mould M2 and is providing a rigid bottom structure of the cellulose product 1.

The closed collar section 1c_{C} is positioned at a distance above one or more lowest parts 1c_{L} of the closed bottom portion 1c in the longitudinal direction, as understood from for example FIG. 3b. With this configuration, the one or more lowest parts 1c_{L} of the cellulose product 1 can be used for providing a stable bottom structure of the cellulose product 1, where the bottom structure suitably has an inwardly curved surface configuration. The cellulose product 1 has with this construction a high stability when placed on an object surface, such as for example a table surface or other surface. In the embodiment illustrated in FIG. 3b, the cellulose product 1 is arranged with several lowest parts 1c_{L} for a high stability.

In the embodiment shown in FIGS. 2, 3a-f, 4a-e, 5a-f, 6a-f and 7, the cellulose product 1 is formed in different forming steps in the pre-forming mould M1 and the forming mould M2. The pre-forming mould M1 is used for forming the neck portion 1a of the cellulose product 1, and partly forming the closed bottom portion 1c of the cellulose product 1 into a semi-closed bottom portion 1c_{S}. The forming mould M2 is used for forming the upper portion 1b of the cellulose product 1 and forming the closed bottom portion 1c from the semi-closed bottom portion 1c_{S}. Upon forming of the semi-closed bottom portion 1c_{S} in the pre-forming mould M1, a collar section 1c_{C} of the semi-closed bottom portion 1c_{S} is established by forces acting on the shaped cellulose blank structure 2_{S}.

Each individual cellulose product 1 is formed in main sequential forming steps in the pre-forming mould M1 and the forming mould M2. The semi-closed bottom portion 1c_{S} is formed in a first sequential forming step in the pre-forming mould M1, the neck portion 1a is formed in a second sequential forming step in the pre-forming mould M1, and the upper portion 1b together with the closed bottom portion 1c is formed in a third sequential forming step in the forming mould M2, as will be further described

### Below.

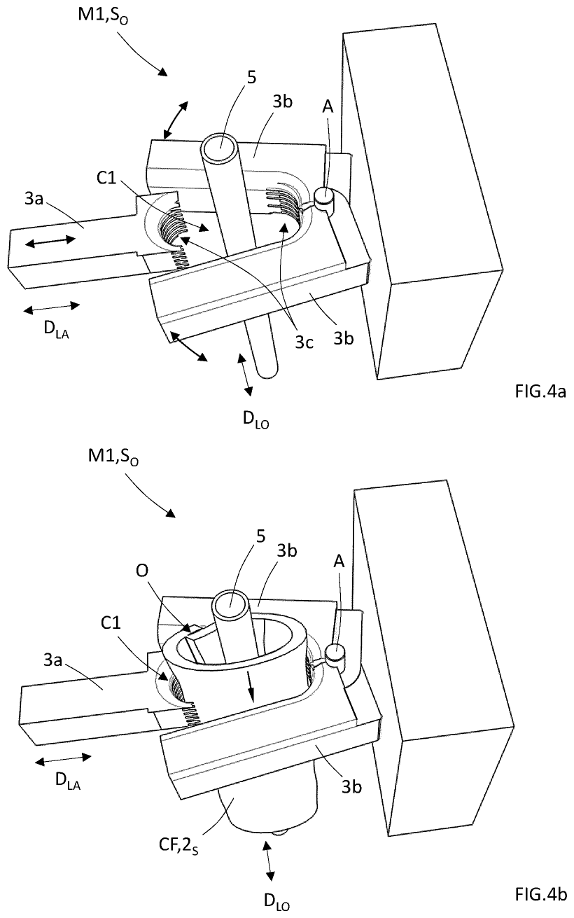

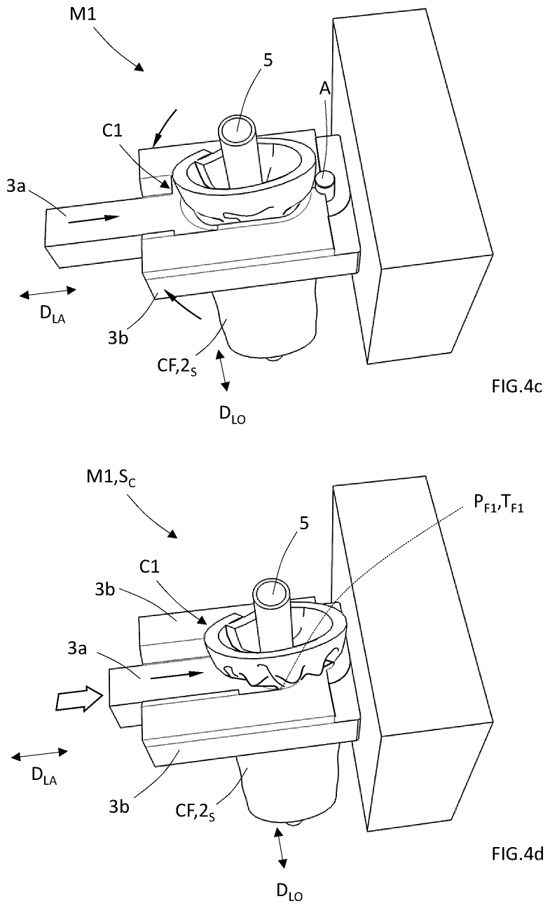

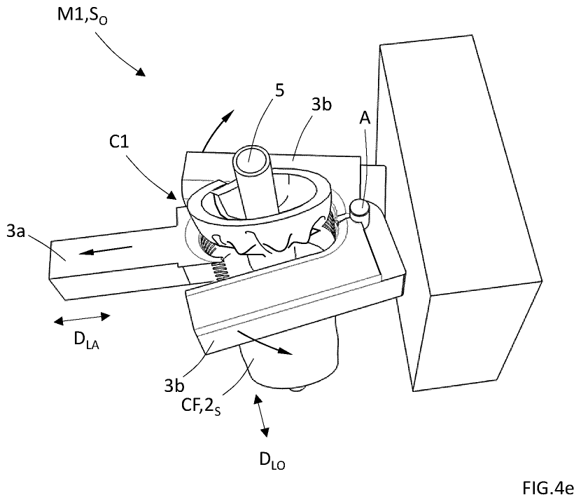

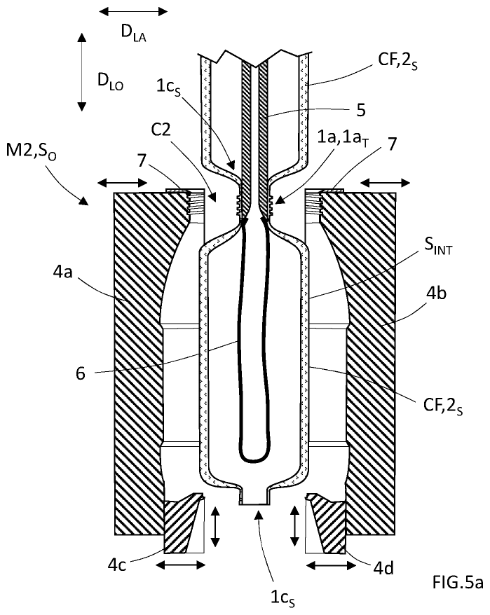

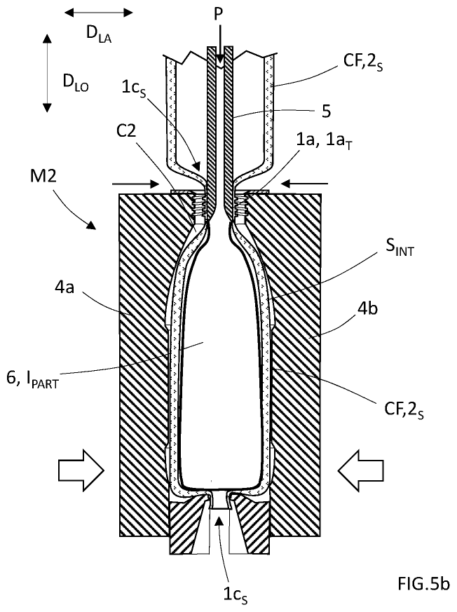

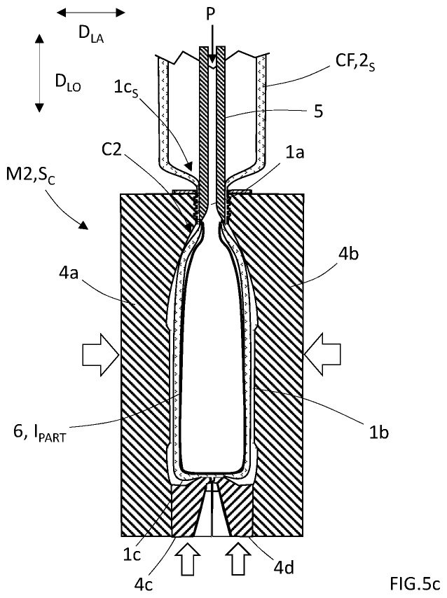

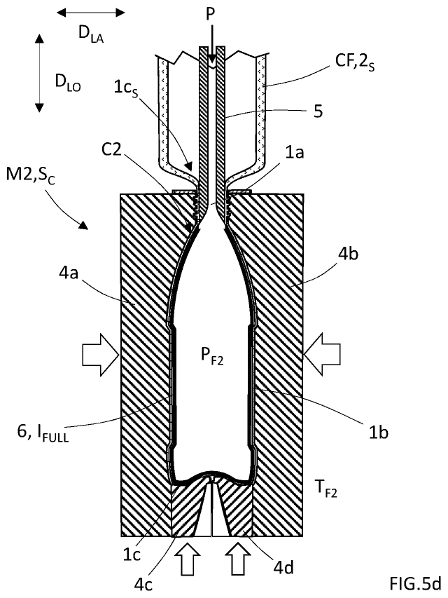

The pre-forming mould M1 has a dual configuration for simultaneous forming of a neck portion 1a and a semi-closed bottom portion 1c_{S}, and as understood from the illustrated configuration of the product forming unit U shown in for example FIGS. 4a-e, the simultaneous forming in the pre-forming mould M1 is resulting in the forming of a neck portion 1a and a semi-closed bottom portion 1c_{S} of different products. In this way, the pre-forming mould M1 is configured for forming a neck portion 1a of a leading cellulose product 1L simultaneously with forming a semi-closed bottom portion 1c_{S} of a directly following trailing cellulose product 1T from the shaped cellulose blank structure 2_{S}, as will be further described below.

The pre-forming mould M1 is schematically illustrated in FIGS. 4a-e. In FIGS. 4a-e, the shaped cellulose blank structure 2_{S} is sectioned for illustrative purposes, where only a part of the shaped cellulose blank structure 2_{S} is shown. The pre-forming mould M1 comprises openable and closable mould parts 3a,3b arranged around a pressure lance 5. An outer mould part 3a is movably arranged relative to the pressure lance 5 as indicated with the arrow in FIG. 4a. The outer mould part 3a is suitably displaceable in reciprocating linear movements towards and away from the pressure lance 5. An inner mould part 3b comprises clamping arm sections pivotably arranged relative to each other around a pivoting axis A, as indicated with arrows in FIG. 4a. The inner mould part 3b is extending partly around the pressure lance 5. The inner mould part 3a is suitably displaceable in pivoting movements around the pivoting axis A towards and away from the pressure lance 5. In FIG. 4a, the pre-forming mould M1 is arranged in an open state S_{O}, where the mould parts 3a,3b have been displaced away from the pressure lance, allowing the shaped cellulose blank structure 2_{S} to be fed around the pressure lance 5 and through the mould parts 3a,3b, as shown in FIG. 4b.

The pre-forming mould M1 comprises a forming cavity C1 formed between the mould parts 3a,3b and the pressure lance 5, as shown in FIGS. 4a-e. The feeding unit F is feeding the shaped cellulose blank structure 2_{S} around the pressure lance 5 and through the mould parts 3a,3b when the mould parts 3a,3b are arranged in the open state S_{O}. When the shaped cellulose blank structure 2_{S} is arranged in the position shown in FIG. 4b, where the shaped cellulose blank structure 2_{S} is positioned between the pressure lance 5 and the mould parts 3a,3b, the mould parts may be displaced towards the pressure lance 5, as indicated with arrows in FIG. 4c. Suitably, the inner mould part 3b is pivoted towards the pressure lance 5 in a movement faster than the displacement of the outer mould part 3a for an efficient forming process. When the inner mould part 3b is closed, as shown in FIG. 4c, the outer mould part 3a may be further pushed towards the pressure lance 5 with a suitable pushing force to a closed state Sc of the pre-forming mould M1, as indicated with the arrow in FIG. 4d. When closed, the mould parts 3a,3b are pressing the shaped cellulose blank structure 2_{S} radially against the pressure lance 5 for simultaneously forming the neck portion 1a and the semi-closed bottom portion 1c_{S} in the forming cavity C1. During the pressing operation, a forming pressure P_{F1} and a forming temperature T_{F1} are at least applied onto the part of the shaped cellulose blank structure 2_{S} used for forming the neck portion 1a in the forming cavity C1. After the forming operation the pre-forming mould M1 is returned to the open state S_{O}, as shown in FIG. 4e. In FIG. 3e, the formed neck portion 1a and the semi-closed bottom portion 1c_{S} with the collar section 1c_{C} are schematically shown, where the collar section 1c_{C} is the most narrow portion of the semi-closed bottom portion 1c_{S} that is transitioning towards the neck portion 1a. As understood from the figure, the collar section 1c_{C} has a collar opening 1c_{O} that is corresponding to the flow opening 1a_{O} of the neck portion 1a.

The pre-forming mould M1 suitably comprises a thread forming section 3c, as shown in for example FIG. 4a. The thread forming section 3c is forming the threaded section 1d of the neck portion 1a upon forming of the neck portion 1a in the pre-forming mould M1. The thread forming section 3c is arranged with a threaded pattern for efficient forming of threads of the threaded section 1d on the outside surface of the neck portion 1a in the pre-forming mould, as understood from the figures.

The applied forming pressure P_{F1} in the pre-forming mould M1 is suitably in the range of 1-1000 MPa, preferably 4-200 MPa, and the applied forming temperature T_{F1} is suitably in the range of 60-300° C., preferably 100-200° C.

The mould parts 3a,3b of the pre-forming mould M1 are suitably arranged as stiff mould parts. With stiff mould parts is meant that the mould parts are made of a stiff material with limited deformation capabilities, such as for example steel, aluminium, composite materials or a combination of different materials. The section of the pressure lance 5 extending through the pre-forming mould M1 is suitably made of a stiff material with limited deformation capabilities, such as for example steel, aluminium, composite materials or a combination of different materials. This section of the pressure lance 6 may be stiffer than the other parts of the pressure lance 6 to withstand the high forming pressure in the pre-forming mould M1. In one embodiment, the section of the pressure lance 5 extending through the pre-forming mould M1 is reinforced with an outer structural piece of material surrounding the pressure lance 5, establishing a strong structural part around the pressure lance 5.

The mould part M1 may further comprise a heating unit. The heating unit is configured for applying the forming temperature T_{F1} onto the shaped cellulose blank structure 2_{S} in the forming cavity C1 during the forming operation in the pre-forming mould M1. The heating unit may have any suitable configuration. The heating unit may be integrated in or cast into the mould parts 3a,3b, and suitable heating devices are e.g. electrical heaters, such as resistor elements, or fluid heaters. Other suitable heat sources may also be used.

The shaped cellulose blank structure 2_{S} may in other non-illustrated embodiments be pre-shaped into an hourglass-shape before being inserted into the pre-forming mould M1 for facilitating the forming operation in the pre-forming mould M1. Suitable shaping elements may be used for delimiting the radial extension of sections of the pre-shaped cellulose blank structure 2_{S} for enabling the hourglass shape. The shaping elements may for example be arranged as a snare structure or snare-like element arranged around the shaped cellulose blank structure 2_{S} upstream the pre-forming mould M1, where the snare structure or snare-like element upon constriction is delimiting the radial extension of a section of the shaped cellulose blank structure 2_{S}. After pre-shaping, the snare structure or snare-like element is returning to a non-constricted state for feeding of the pre-shaped section of the shaped cellulose blank structure 2_{S} to the pre-forming mould M1.

As described above, each individual cellulose product 1 is formed in sequential steps in the pre-forming mould M1 and the forming mould M2. When the semi-closed bottom portion 1c_{S} and the neck portion 1a for an individual product 1 have been formed in the first sequential and second sequential forming steps in the pre-forming mould M1, the semi-closed bottom portion 1c_{S} and the neck portion 1a together with an intermediate section S_{INT} of the shaped cellulose blank structure 2_{S} between the formed semi-closed bottom portion 1c_{S} and the neck portion 1a is transported to the forming mould M2. The upper portion 1b together with the closed bottom portion is formed in a third sequential forming step in the forming mould M2, as will be further described below.

A shaped cellulose blank structure 2_{S} is schematically shown in FIG. 3c. The shaped cellulose blank structure 2_{S} is during the forming operation transported through the pre-forming mould M1 and thereafter through the forming mould M2. The shaped cellulose blank structure 2_{S} is for illustrative purposes to better understand the bottle forming process schematically divided into a first section S1, an intermediate section S_{INT}, and a second section S2, as shown in FIGS. 3c-d, where the different sections are used for forming different parts of the cellulose product 1. In the first sequential forming step, the first section S1 is fed to the pre-forming mould M1. The first section S1 of the shaped cellulose blank structure 2_{S} is used for forming the semi-closed portion 1c_{S} of the cellulose product 1 simultaneously with forming the neck portion 1a of a directly preceding cellulose product 1P, as understood from FIG. 3e. Thereafter, in the second sequential forming step, the following second section S2 arranged at a distance from the first section S1 is fed to the pre-forming mould M1. The second section S2 of the shaped cellulose blank structure 2S is used for forming the neck portion 1a of the cellulose product 1 simultaneously with forming the semi-closed portion 1c_{S} of a directly following cellulose product 1F, as understood from FIG. 3e. The part of the shaped cellulose blank structure 2_{S} shown in FIG. 3e is illustrating the configuration after the two sequential forming steps of forming operations in the pre-forming mould M1. As understood from FIG. 3e, the intermediate section S_{INT} has not yet been shaped or formed in the forming mould M2 after the two sequential steps of forming operations in the pre-forming mould M1. As described above, upon forming of the semi-closed bottom portion 1c_{S} in the pre-forming mould M1, the collar section 1c_{C} of the semi-closed bottom portion 1c_{S} is established by forces acting on the shaped cellulose blank structure 2_{S}. The collar section 1c_{C} is defined as the most narrow portion of the semi-closed bottom portion 1c_{S} that is transitioning towards the neck portion 1a, as for example shown in FIG. 3e.

A row of cellulose products 1 are produced after each other from the shaped cellulose blank structure 2_{S}, as understood from for example FIG. 3e. As indicated in FIG. 3e, consecutive cellulose products can be formed from the shaped cellulose blank structure 2_{S}, which in the figure has been pre-shaped in the pre-forming mould M1 as described above. In FIG. 3f, the relationship between following cellulose products is illustrated, where a leading cellulose product 1L is directly followed by a trailing cellulose product 1T. The expressions leading and trailing are in this respect referring to the feeding direction through the forming moulds, and a leading cellulose product 1L is thus formed before a trailing cellulose product 1T in the pre-forming mould M1 and forming mould M2. If referring to FIGS. 3e-f, the preceding cellulose product 1P illustrated in FIG. 3e is a leading cellulose product 1L relative to the directly succeeding cellulose product 1, and the cellulose product 1 is a trailing product relative to the preceding cellulose product 1P. If again referring to FIGS. 3e-f, the cellulose product 1 illustrated in FIG. 3e is a leading cellulose product 1L relative to the directly succeeding following cellulose product 1F, and the following cellulose product 1F is a trailing product relative to the cellulose product 1. The expressions above will be used in the following to define relationships in the cellulose product forming flow.

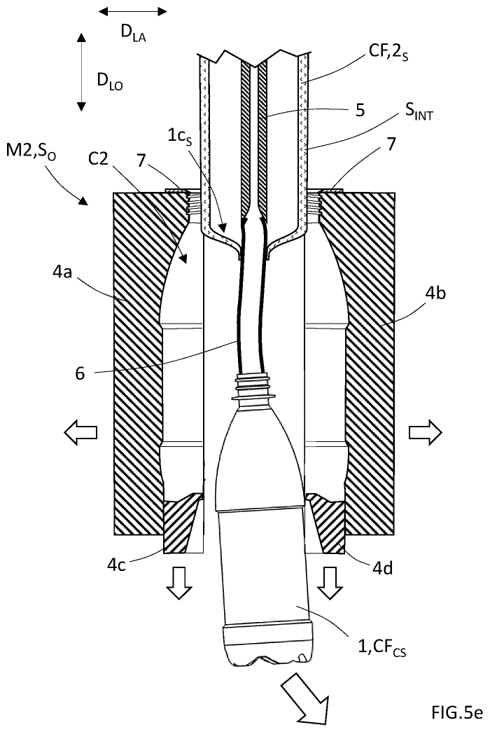

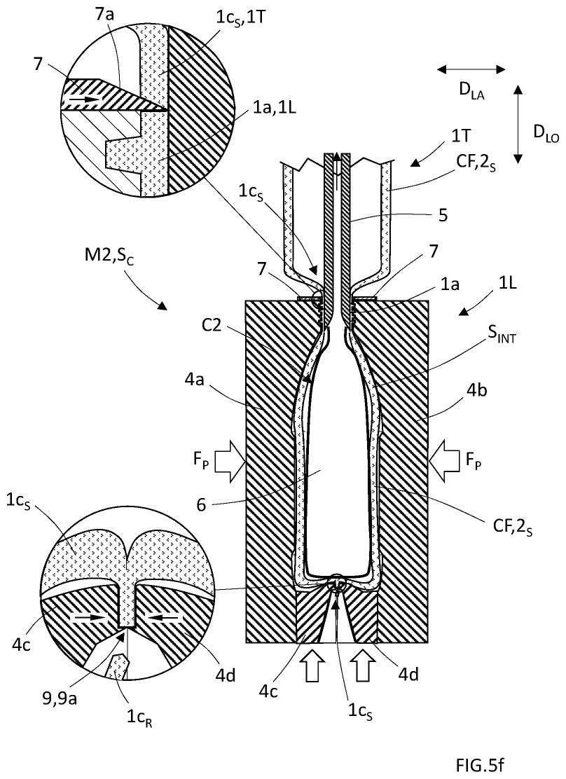

The forming mould M2 is schematically illustrated in FIGS. 5a-f. The forming mould M2 comprises openable and closable upper mould parts 4a,4b and lower mould parts 4c,4d forming a forming cavity C2. A flexible membrane 6 is arranged in the forming cavity C2, and the flexible membrane 6 is connected to and arranged in fluid communication with the pressure lance 5. The pressure lance 5 is suitably extending to or partly into the forming cavity C2. A pressure medium P is used for inflating the flexible membrane 6 when dry-forming the cellulose products 1 in the forming mould M2. The forming mould M2 comprises in this embodiment two upper mould parts 4a, 4b and two lower mould parts 4c,4d.

A first upper mould part 4a and a second upper mould part 4b are movably arranged relative to each other and relative to the flexible membrane 6 in a lateral direction D_{LA}, as indicated with the double arrows in FIG. 5a. A first lower mould part 4c and a second lower mould part 4d are movably arranged relative to each other in the lateral direction D_{LA} and movably arranged in a longitudinal direction D_{LO} towards the flexible membrane 6, as indicated with the double arrows in FIG. 5a. The first lower mould part 4c may suitably be movably connected to the first upper mould part 4a, and the second lower mould part 4d may suitably be movably connected to the second upper mould part 4b. The lower mould parts 4c,4d are in this way configured for being displaced relative to the corresponding upper mould parts 4a,4b in the longitudinal direction D_{LO}.

The first upper mould part 4a is suitably displaceable in the lateral direction D_{LA} in reciprocating linear movements towards and away from the second upper mould part 4b and the flexible membrane 6. The second upper mould part 4b is suitably displaceable in the lateral direction D_{LA} in reciprocating linear movements towards and away from the first upper mould part 4a and the flexible membrane 6. The first lower mould part 4c is suitably displaceable in the lateral direction D_{LA} in reciprocating linear movements towards and away from the second lower mould part 4d. The second lower mould part 4d is suitably displaceable in the lateral direction D_{LA} in reciprocating linear movements towards and away from the first lower mould part 4c. The first lower mould part 4c is suitably displaceable in the longitudinal direction D_{LO} in reciprocating linear movements towards and away from the flexible membrane 6. The second lower mould part 4d is suitably displaceable in the longitudinal direction D_{LO} in reciprocating linear movements towards and away from the flexible membrane 6.

When closing the forming mould M2, the upper mould parts 4a,4b are moved towards each other together with moving the lower mould parts 4c, 4d towards each other in the lateral direction D_{LA}, and the lower mould parts 4c,4d are moved relative to the respective upper mould parts 4a,4b in the longitudinal direction D_{LO} towards the flexible membrane 6.

When opening the forming mould M2, the upper mould parts 4a,4b are moved away from each other together with moving the lower mould parts 4c, 4d away from each other in the lateral direction D_{LA}, and the lower mould parts 4c,4d are moved relative to the respective upper mould parts 4a,4b in the longitudinal direction D_{LO} away from the flexible membrane 6.

In FIG. 5a, the forming mould M2 is arranged in an open state S_{O}, where the upper mould parts 4a,4b have been displaced in the lateral direction D_{LA} away from each other and away from the flexible membrane 6, and the lower mould parts 4c,4d have been displaced in the lateral direction D_{LA} and the longitudinal direction D_{LO} away from each other and away from the flexible membrane 6. In the open state S_{O}, the shaped cellulose blank structure 2_{S} is fed around the flexible membrane 6 and received between the upper mould parts 4a,4b and lower mould parts 4c,4d, into the position shown in FIG. 5a.

In other non-illustrated embodiments, one of the first upper mould part 4a and the second upper mould part 4b may be arranged as a stationary mould part, where the other mould part is movably arranged.

The forming mould M2 is forming the upper portion 1b of the cellulose product 1 from the intermediate section S_{INT}, and the closed bottom portion 1c of the cellulose product 1 from the semi-closed bottom portion 1c_{S} in the forming cavity C2. The feeding unit F is feeding the formed semi-closed bottom portion 1c_{S}, the intermediate section S_{INT}, and the formed neck portion 1a around the pressure lance 5 to the forming mould M2 when the pre-forming mould M1 and the forming mould M2 are arranged in open states S_{O}. The feeding unit F is thus feeding the shaped cellulose blank structure 2_{S} in the longitudinal direction D_{LO} around the pressure lance 5 and flexible membrane 6 into the forming mould M2 for arranging the cellulose fibres CF into the open forming mould M2. The feeding unit F is in this way feeding the formed semi-closed bottom portion 1c_{S} and the intermediate section S_{INT} of the shaped cellulose blank structure 2_{S} between the formed semi-closed bottom portion 1c_{S} and a directly following formed trailing neck portion 1a_{T} into the forming mould M2, as shown in FIG. 5a. The feeding of the shaped cellulose blank structure 2_{S} is stopped when positioned in the open forming mould M2.

When the shaped cellulose blank structure 2_{S} with the semi-closed bottom portion 1c_{S} and the intermediate section S_{INT} is arranged in the position shown in FIG. 5a, and thus positioned between the first upper mould part 4a and the second upper mould part 4b, and between the first lower mould part 4c and the second lower mould part 4d, with the flexible membrane 6 arranged inside the shaped cellulose blank structure 2_{S}, the forming mould M2 is closed around the shaped cellulose blank structure 2_{S}. Upon closing of the forming mould M2, the upper mould parts 4a,4b are moved towards each other in a lateral direction D_{LA}, and the lower mould parts 4c,4d are moved towards each other in the lateral direction D_{LA} together with the upper mould parts 4a,4b and in the longitudinal direction D_{LO} towards the flexible membrane 6. The mould parts are thus displaced for arranging the forming mould M2 into a closed state S_{C}, as shown in FIGS. 5c-d, and the movements of the upper mould parts 4a,4b and the lower mould parts 4b,4c of the forming mould M2 towards the closed state Sc are indicated with arrows in FIGS. 5b-c. Upon displacement of the upper mould parts 4a,4b in the lateral direction D_{LA}, and the lower mould parts 4c,4d in the lateral direction D_{LA} and the longitudinal direction D_{LO}, the mould parts are pushing the semi-closed bottom portion 1c_{S} towards a closed configuration, as shown in FIGS. 5b-c and illustrated more in detail in FIG. 5f. The first lower mould part 4c and the second lower mould part 4d are gripping the collar section 1c_{C} of the semi-closed bottom portion 1c_{S} when moved towards each other for an efficient forming process. The semi-closed bottom portion 1c_{S} is in this way pushed towards a closed configuration upon closing the lower mould parts 4c,4d of the forming mould M2 around the semi-closed bottom portion 1c_{S}, and the collar opening 1c_{O} of the semi-closed bottom portion 1c_{S} is closed by the forces exerted by the lower mould parts 4c,4d. In FIG. 5d, the forming mould M2 is arranged in the closed state S_{C}, in which the shaped cellulose blank structure 2_{S} can be dry-formed into the cellulose product 1. To secure the closed state Sc of the forming mould M2 during the forming process, the mould parts may be pushed with suitable pushing forces.

Upon movement of the mould parts in the lateral direction D_{LA} and the longitudinal direction D_{LO}, the flexible membrane 6 may be partly inflated with the pressure medium P into a partly inflated state I_{PART}, as shown in FIGS. 5b-c. In the partly inflated state I_{PART}, the partly inflated flexible membrane 6 is pushing the cellulose fibres CF towards the lower mould parts 4c,4d and/or the lower mould parts 4c,4d are pushing the cellulose fibres CF towards the partly inflated flexible membrane 6 for an efficient distribution of the cellulose fibres in the forming cavity C2. The partly inflated flexible membrane 6 is thus enabling an efficient distribution of the cellulose fibres CF in the forming cavity C2 upon movement of the mould parts, and it should be understood that the flexible membrane 6 may be partly inflated with the pressure medium P before movement or upon movement of the lower mould parts 4c,4d in the longitudinal direction D_{LO} towards the flexible membrane 6. During the closing of the forming mould M2, the cellulose fibres CF are pushed towards a closed bottom configuration by means of the lower mould parts 4c,4d when moved in the lateral direction D_{LA} and the longitudinal direction D_{LO}, for pre-shaping the closed bottom portion 1c by the forces exerted by the lower mould parts 4c,4d, as shown in FIGS. b-c.

When the forming mould M2 is arranged in the closed state S_{C}, the flexible membrane 6 is inflated with the pressure medium P into a fully inflated state I_{FULL} for establishing a forming pressure P_{F2} for an efficient dry-forming operation of the cellulose product 1 in the forming mould M2, as shown in FIG. 5d. In the closed state S_{C}, the upper mould parts 4a,4b and the lower mould parts 4c,4d together with the flexible membrane 6 are forming the closed bottom portion 1c and the upper portion 1b of the cellulose product 1 by inflating the flexible membrane 6 towards the mould parts. The flexible membrane 6 is inflated with the pressure medium P entering from the pressure lance 5, as indicated with the arrow in FIG. 5d. When the forming mould M2 is closed around the semi-closed bottom portion 1c_{S} and the intermediate section S_{INT}, the further closed semi-closed bottom portion 1c_{S} and the intermediate section S_{INT} are pressed against the mould parts by means of the inflated flexible membrane 6 for applying the forming pressure P_{F2} onto the cellulose fibres CF. The flexible membrane 6 is thus inflated with the pressure medium P entering from the pressure lance 5, and the forming pressure P_{F2} is applied onto the intermediate section S_{INT} and the further closed semi-closed bottom portion 1c_{S} by pressing the intermediate section S_{INT} and the further closed semi-closed bottom portion 1c_{S} against the upper mould parts 4a,4b and lower mould parts 4c,4d by means of the inflated flexible membrane 6. A forming temperature T_{F2} is applied onto the further closed semi-closed bottom portion 1c_{S} and the intermediate section S_{INT} in the forming mould M2. In this way the forming pressure P_{F2} and the forming temperature T_{F2} are enabling the dry-forming of the cellulose product 1 with the closed bottom portion 1c and the upper portion 1c into a three-dimensional compressed fibre structure CF_{CS}.

The applied forming pressure P_{F2} in the forming mould M2 is suitably in the range of 1-100 MPa, preferably 4-20 MPa, and the applied forming temperature T_{F2} is suitably in the range of 60-300° C., preferably 100-200° C.

After the forming operation, the forming mould M2 is returned to the open state S_{O}, as shown in FIG. 5e, for an easy removal of the cellulose product 1 from the forming mould M2 and for repeating the dry-forming operation. After forming of the cellulose product 1, the flexible membrane 6 is deflated and the forming mould M2 is opened. Upon opening the forming mould M2, the upper mould parts 4a,4b are moved away from each other in the lateral direction D_{LA}, and the lower mould parts 4c, 4d are moved away from each other in the lateral direction D_{LA} and in the longitudinal direction D_{LO} away from the flexible membrane 6, as understood from FIG. 5e. Upon opening of the forming mould M2, the lower mould parts 4c,4d may first be moved in the longitudinal direction D_{LO} away from the flexible membrane 6 and thereafter away from each other in the lateral direction D_{LA}, or the lower mould parts 4c,4d may be simultaneously moved away from each other in the lateral direction D_{LA} and in the longitudinal direction D_{LO} away from the flexible membrane 6. As described above, the lower mould parts 4c,4d may be movably connected to the upper mould parts 4a,4b and configured for being displaced relative to the upper mould parts 4a,4b in the longitudinal direction D_{LO}. With such a configuration, the upper mould parts 4a,4b are moved away from each other together with moving the lower mould parts 4c, 4d away from each other in the lateral direction D_{LA} upon opening of the forming mould M2, and the lower mould parts 4c,4d are moved relative to the upper mould parts in the longitudinal direction Do away from the flexible membrane 6 upon opening of the forming mould M2.

The bottom of the formed rigid closed bottom portion 1c of the cellulose product 1 formed into a bottle has an inwardly curved surface configuration, as understood from for example FIG. 3b. The closed collar section 1c_{C} of the semi-closed bottom portion 1c_{S} is in this way arranged above the lowermost portions of the cellulose product 1, as shown in FIG. 5f. The inwardly curved surface configuration is enabled by the shape of the lower mould parts 4c,4d and the inflation of the flexible membrane 6 upon forming in the forming mould M2, where the flexible membrane 6 is pushing the semi-closed bottom portion 1c_{S} towards the lower mould parts 4c,4d. The inwardly curved surface configuration is providing a stable bottom structure of the cellulose product 1. The cellulose product 1 has with this construction a high stability when placed on an object surface, such as for example a table surface or other surface.

The already formed upper portion 1a is as understood from FIGS. 5a-f arranged within the forming mould M2 during the forming operation. It should however be understood that no forming pressure is applied to the upper portion 1a in the forming mould M2 during the forming of the cellulose product 1.

The upper mould parts 4a,4b and the lower mould parts 4c,4d of the forming mould M2 are suitably arranged as stiff mould parts. With stiff mould parts is meant that the mould parts are made of a stiff material with limited deformation capabilities, such as for example steel, aluminium, composite materials or a combination of different materials.

The second mould part M2 may further comprise a heating unit. The heating unit is configured for applying the second forming temperature T_{F2} onto the shaped cellulose blank structure 2_{S} and the semi-closed bottom portion 1c_{S} during the forming operation in the forming mould M2. The heating unit may have any suitable configuration. The heating unit may be integrated in or cast into the upper mould parts 4a,4b and/or the lower mould parts 4c,4d, and suitable heating devices are e.g. electrical heaters, such as resistor elements, or fluid heaters. Other suitable heat sources may also be used.

The flexible membrane 6 is made of a material that is allowed to deform when being inflated upon forming of the cellulose products 1 in the forming mould M2. Suitable materials are for elastomeric compositions, such as for example rubber, or other elastomers exhibiting elastic or rubber-like properties. The material used in the flexible membrane 6 suitably withstands high pressure levels from the pressure medium P when being inflated, as well as repeated inflation and deflation cycles.

In other non-illustrated embodiments, the flexible membrane 6 may be made of a liquid impermeable single-use plastic film or other suitable material that is adhering to the cellulose product 1 during the forming process. In this way, the plastic film or other suitable material is forming a liquid barrier inside the formed cellulose product 1. With this configuration, a new flexible membrane 6 is provided for each product forming operation in the forming mould M2.

The pressure medium P is used for establishing the second forming pressure P_{F2} in the forming cavity C2 upon inflating the flexible membrane 6. The pressure medium P used in the forming operation in the forming mould M2 may be a liquid composition or a gas, such as for example oil, water, or air. In the embodiment described above, where the flexible membrane 6 is made of a single-use plastic film or other suitable material that is adhering to the cellulose product 1 during the forming process, the pressure medium P may be a beverage or other liquid that is pressurizing the flexible membrane 6 when forming the cellulose product 1. In this way, the beverage or other liquid is directly filled into the cellulose product 1 during the forming process.

The product forming unit U comprises a fluid control device D, as schematically indicated in FIG. 2. The pressure lance 5 is at a first end 5a arranged in fluid communication with the fluid control device D, and the pressure lance 5 is at a second end 5b arranged in fluid communication with the flexible membrane 6. The fluid control device D is configured for inflating the flexible membrane 6 with the pressure medium P via the pressure lance 5 upon forming in the forming mould M2. The fluid control device D is further arranged for deflating the flexible membrane 6 via the pressure lance 5 after the forming operation in the forming mould M2. The fluid control device may have any suitable configuration, and may comprise hydraulic or pneumatic cylinders, fluid pumps, compressors, or other pressure establishing devices for delivering pressurized pressure medium to the flexible membrane via the pressure lance 5. The product forming unit U may further comprise a control unit for controlling the forming operation.

In the embodiment described above, upon closing the forming mould M2, the lower mould parts 4c,4d may first be moved towards each other in the lateral direction D_{LA} and thereafter in the longitudinal direction D_{LO} towards the flexible membrane 6. Alternatively, upon closing the forming mould M2, the lower mould parts 4c,4d are simultaneously moved towards each other in the lateral direction D_{LA} and in the longitudinal direction D_{LO} towards the flexible membrane 6.

The product forming unit U further comprises a cutting device 7 arranged in the upper mould parts 4a,4b or in connection to the upper mould parts 4a,4b, of the forming mould M2. In the embodiment illustrated in FIGS. 5a-f, the cutting device 7 is arranged in the second mould part M2. The cutting device 7 may be arranged with cutting edges 7a on the first upper mould part 4a and the second upper mould part 4b respectively as shown in for example FIG. 5f. The cutting device 7 is cutting off the formed neck portion 1a of a leading cellulose product 1L from the semi-closed bottom portion 1c_{S} of a directly following trailing cellulose product 1T by means of the cutting device 7 upon closing of the forming mould M2 during the forming operation of the cellulose product 1 in the forming mould M2, as shown in FIG. 5f. In FIG. 5f, the forming mould M2 is illustrated in the closed state Sc before the full inflation of the flexible membrane 6 with the pressure medium P, and the cutting operation is suitably completed when the second mould part M2 is closed.

According to the embodiment shown in FIGS. 5a-f, the pressure lance 5 extends into the forming mould M2. The cutting device 7 may be arranged to work against and around the pressure lance 5 such that the pressure lance 5 acts as an anvil against which the cutting edges 7a are pressed, and the neck portion 1a is in this way separated from the semi-closed bottom portion 1c_{S} accordingly. Here, the pressure lance 5 may comprise a reinforced portion that can withstand the pressure from the cutting edge. The reinforced portion can be arranged as a thicker material portion of the pressure lance 5 and/or can be made from a different material than adjacent portions of the pressure lance 5. As an alternative, the entire pressure lance 5 is made from a suitable material than can withstand pressure, both in the pre-forming mould M1 and the forming mould M2. The reinforced portion can alternatively be arranged as a separate piece of material arranged around the pressure lance 5.

The product forming unit U may further comprise an auxiliary cutting device 9 arranged in the second mould part M2, as illustrated in FIG. 5f. The auxiliary cutting device 9 may be arranged with cutting edges 9a on the first lower mould part 4c and the second lower mould part 4d respectively as indicated in FIG. 5f. The auxiliary cutting device 9 is cutting off residual parts 1c_{R} of the closed collar section 1c_{C} of the semi-closed bottom portion 1c_{S} that may extend out from the forming mould M2 when arranged in the closed state Sc.

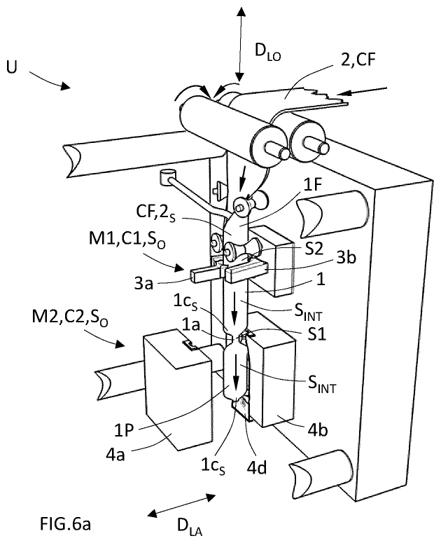

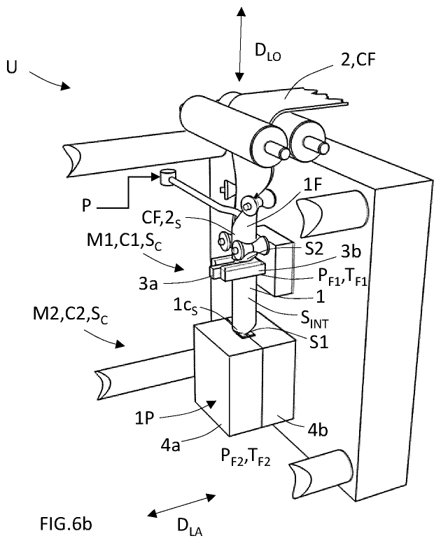

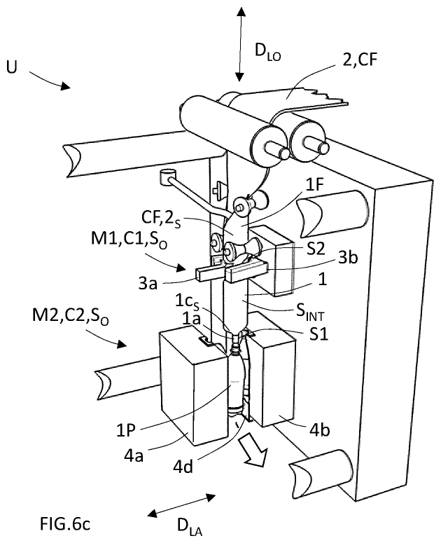

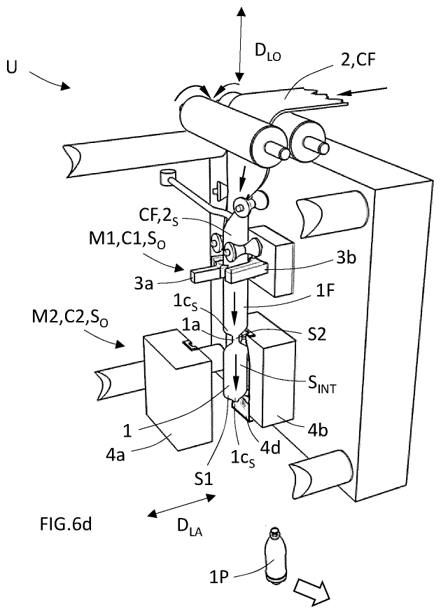

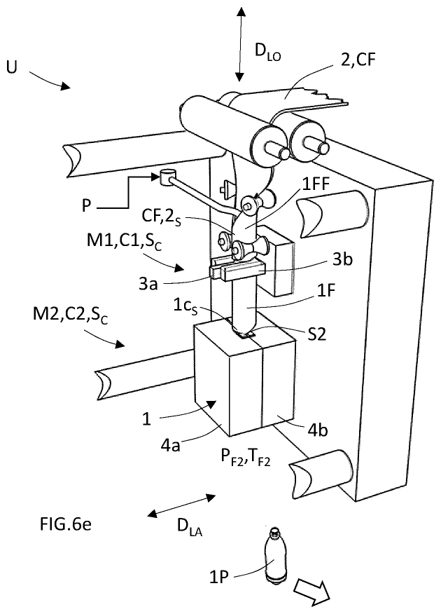

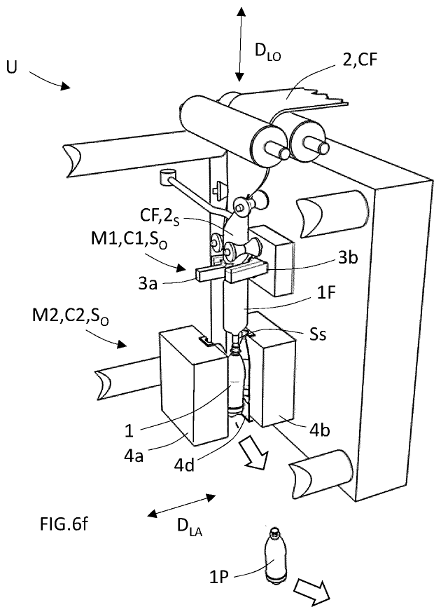

The dry-forming process of the cellulose product 1 shaped as a bottle will be described below in connection to FIGS. 6a-f. Throughout the dry-forming process, the air-formed cellulose blank structure 2 is shaped into a shaped cellulose blank structure 2_{S}, where the shaped cellulose blank structure 2_{S} has a tube-like configuration as described above.

In FIG. 6a, the pre-forming mould M1 is arranged in the open state S_{O} and the forming mould M2 is arranged in the open state S_{O}. The position in FIG. 6a is illustrating a position after the first sequential forming step in the pre-forming mould M1 and before the second sequential forming step in the pre-forming mould M1 for forming the cellulose product 1. In this position shown in FIG. 6a, the first section S1 of the shaped cellulose blank structure 2_{S} has already been fed to and further transported from the pre-forming mould M1, where the semi-closed bottom portion 1c_{S} of the cellulose product 1 together with the neck portion 1a of the directly preceding cellulose product 1P were simultaneously formed from the first section S1 in the pre-forming mould M1. In the first sequential forming step, the shaped cellulose blank structure 2_{S} was fed around the pressure lance 5 and through the mould parts 3a,3b of the pre-forming mould M1. Thereafter, the feeding of the shaped cellulose blank structure 2_{S} was stopped when the first section S1 of the shaped cellulose blank structure 2_{S} was arranged in a position aligned with the mould parts 3a,3b. Then, the mould parts 3a,3b were closed and the first section S1 was pressed against the pressure lance 5 by means of the mould parts 3a,3b of the pre-forming mould M1 for forming the semi-closed bottom portion 1c_{S} of the cellulose product 1 in the forming cavity C1, and simultaneously forming the neck portion 1a of the directly preceding cellulose product 1P in the forming cavity C1. Upon forming of the semi-closed bottom portion 1c_{S} of the cellulose product 1 in the pre-forming mould M1, the forming pressure P_{F1} and the forming temperature T_{F1} were applied onto at least the part of the first section S1 of the shaped cellulose blank structure 2_{S} used for forming the neck portion 1a of the preceding cellulose product 1P. It should be understood that the forming pressure P_{F1} and the forming temperature T_{F1} also may be applied to at least a part of the first section S1 used for forming the semi-closed bottom portion 1c_{S} for a more structurally rigid formation of the semi-closed bottom portion 1c_{S}. The forming pressure P_{F1} and the forming temperature T_{F1} may for example be applied to the established collar section 1c_{C} of the semi-closed bottom portion 1c_{S}.

In the position shown in FIG. 6a, the following second section S2 of the shaped cellulose blank structure 2_{S} has been fed to the pre-forming mould M1, and at the same time the formed neck portion 1a, the intermediate section S_{INT}, and the semi-closed bottom portion 1c_{S}, of the preceding cellulose product 1P have been fed to the forming mould M2. When opening the mould parts 3a,3b of the pre-forming mould M1, the shaped cellulose blank structure 2_{S} was fed around the pressure lance 5 and through the mould parts 3a,3b. Thereafter, the feeding of the shaped cellulose blank structure 2_{S} was stopped when the second section S2 of the shaped cellulose blank structure 2_{S} is arranged in a position aligned with the mould parts 3a,3b of the pre-forming mould M1, as understood from FIG. 6a.

In FIG. 6b, the pre-forming mould M1 is arranged in the closed state Sc and the forming mould M2 is arranged in the closed state S_{C}. The position of the shaped cellulose blank structure 2_{S} in FIG. 6b, is illustrating a position in the pre-forming mould M1 during the second sequential forming step for forming the neck portion 1a of the cellulose product 1 and the semi-closed bottom portion 1c_{S} of a directly following cellulose product 1F, and a position in the forming mould M2 where the preceding bottle 1P is formed. In this position shown in FIG. 6b, the neck portion 1a of the cellulose product 1 is formed simultaneously with the semi-closed bottom portion 1c_{S} of a directly following cellulose product 1F from the second section S2 in the pre-forming mould M1. After closing of the mould parts 3a,3b of the pre-forming mould M1, the second section S2 is pressed against the pressure lance 5 by means of the mould parts 3a,3b for forming the neck portion 1a of the cellulose product 1 in the forming cavity C1, simultaneously with forming the semi-closed bottom portion 1c_{S} of the directly following cellulose product 1F in the forming cavity C1. Upon forming of the neck portion 1a of the cellulose product 1 in the pre-forming mould M1, the forming pressure P_{F1} and the forming temperature T_{F1} are applied onto at least the part of the second section S2 of the shaped cellulose blank structure 2_{S} used for forming a structurally rigid neck portion 1a of the cellulose product 1. The threaded section 1d of the neck portion 1a is established by the threaded section 3c upon forming of the neck portion 1a in the pre-forming mould M1. It should be understood that the forming pressure P_{F1} and the forming temperature T_{F1} also may be applied to the at least a part of the second section S2 used for forming the semi-closed bottom portion 1c_{S} of the directly following cellulose product 1F for a more structurally rigid formation of the semi-closed bottom portion 1c_{S}. The forming pressure P_{F1} and the forming temperature T_{F1} may for example be applied to the established collar section 1c_{C} of the semi-closed bottom portion 1c_{S} of the directly following cellulose product 1F.

In FIG. 6c, the pre-forming mould M1 and the forming mould M2 have returned to the open states S_{O}. In FIG. 6c, the formed preceding bottle 1P can be removed from the forming mould M2, as indicated with the arrow. Thereafter, the formed semi-closed bottom portion 1c_{S} of the cellulose product 1 and an intermediate section S_{INT} of the shaped cellulose blank structure 2_{S} between the formed semi-closed bottom portion 1c_{S} of the cellulose product 1 and the formed neck portion 1a of the cellulose product 1 is fed to the forming mould M2, as shown in FIG. 6d.

In the forming mould M2, the upper portion 1b of the cellulose product 1 is formed from the intermediate section S_{INT} and the closed bottom portion 1c of the cellulose product 1 is formed from the semi-closed bottom portion 1c_{S}. To form the cellulose product 1 in the third sequential forming step in the forming mould M2, the semi-closed bottom portion 1c_{S} and the intermediate section S_{INT} is fed around the pressure lance 5 into the forming mould M2, as shown in FIG. 6d. The feeding of the semi-closed bottom portion 1c_{S} and the intermediate section S_{INT} is stopped when positioned between the open mould parts of the forming mould M2, as shown in FIG. 6d.

Thereafter, the forming mould M2 is closed around the semi-closed bottom portion 1c_{S} and the intermediate section S_{INT}. Upon closing of the forming mould M2, the upper mould parts 4a,4b are moved towards each other in the lateral direction D_{LA}, and the lower mould parts 4c,4d are moved towards each other in the lateral direction D_{LA} and in a longitudinal direction D_{LO} towards the flexible membrane, as described in the embodiment above.

When the forming mould M2 is closed, the flexible membrane 6 is inflated with the pressure medium P entering from the pressure lance 5, as understood from FIG. 6e. The forming pressure P_{F2} is applied onto the semi-closed bottom portion 1c_{S} and the intermediate section S_{INT}, and the semi-closed bottom portion 1c_{S} and the intermediate section S_{INT} are pressed against the upper mould parts 4a,4b and the lower mould parts 4c,4d by means of the inflated flexible membrane 6. The forming temperature T_{F2} is applied onto the semi-closed bottom portion 1c_{S} and the intermediate section S_{INT}, for forming the closed bottom portion 1c and the upper portion 1c of the cellulose product 1 into rigid structures. In this way, the cellulose product 1 is dry-formed with a three-dimensional compressed fibre structure having a closed bottom portion 1c and an upper portion 1b.

The earlier formed neck portion 1a of the cellulose product 1 is cut off from the semi-closed bottom portion 1c_{S} of the directly following cellulose product 1F by means of the cutting device 7 during the forming of the cellulose product 1 in the forming mould M2. In FIG. 6e, the neck portion 1a of the following bottle 1F is formed in the pre-forming mould M1 together with the semi-closed bottom portion of a further following cellulose product 1FF. After the forming operation, the flexible membrane 6 is deflated and the upper mould parts 4a,4b and the lower mould parts 4c,4d are opened for removal of the formed cellulose product 1 from the forming mould M2, as shown in FIG. 6f. A negative pressure may be applied to the flexible membrane 6 for an efficient deflating operation.

In one embodiment, the mould parts of the pre-forming mould M1 and mould parts of the forming mould M2 are simultaneously closed. In other embodiments, the mould parts of the pre-forming mould M1 and the mould parts of the forming mould M2 are non-simultaneously closed.

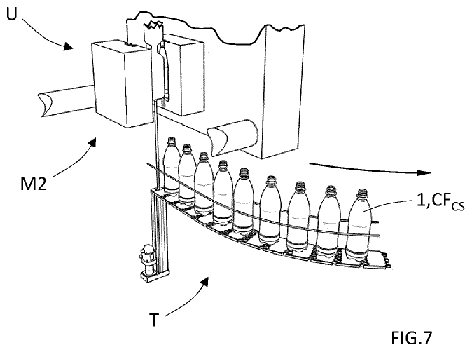

The product forming unit U may further be arranged with a transporting unit T for transportation of formed cellulose products 1 away from the forming mould M2, as shown in FIG. 7.

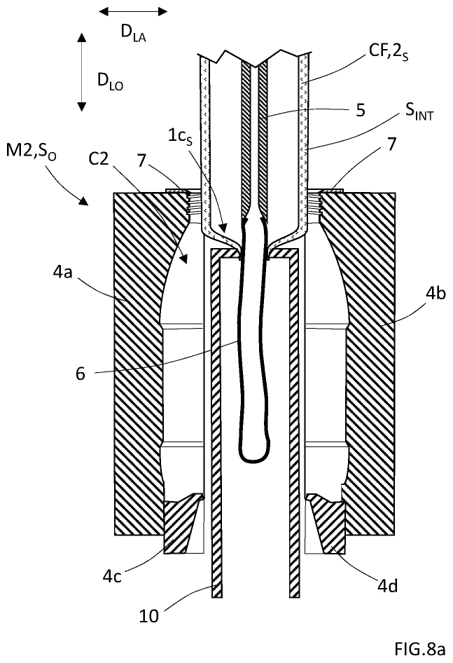

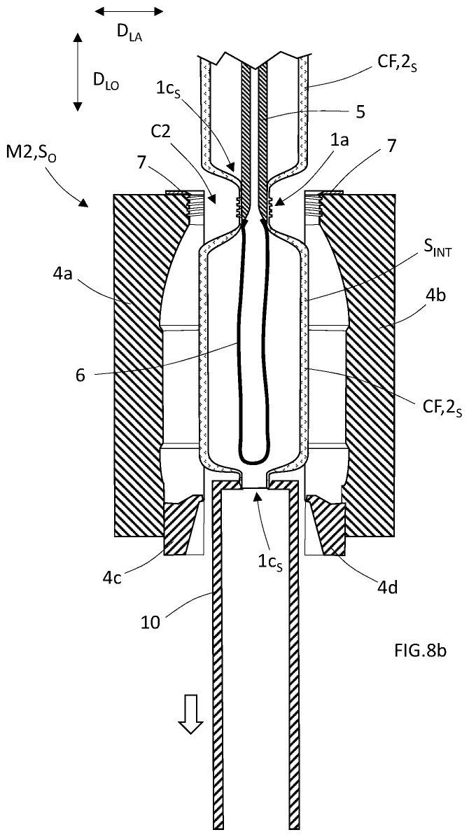

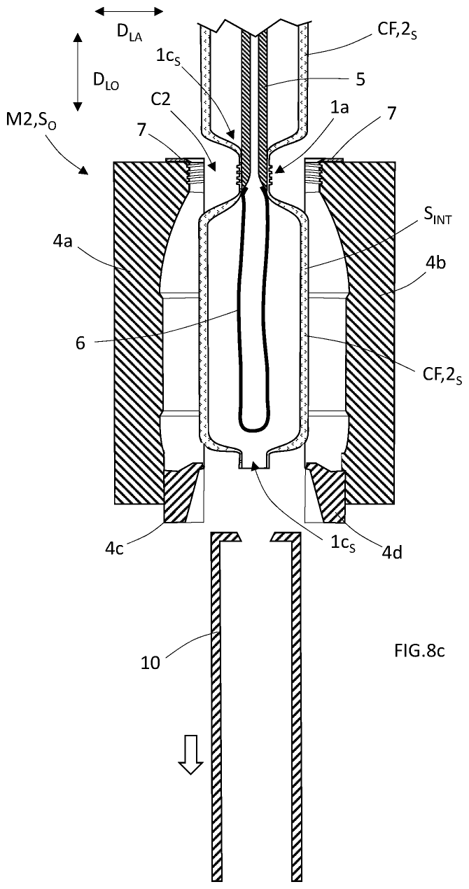

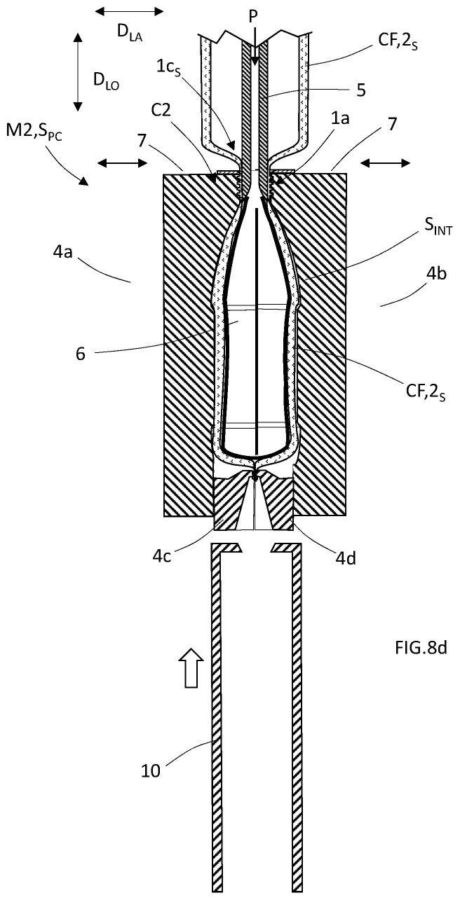

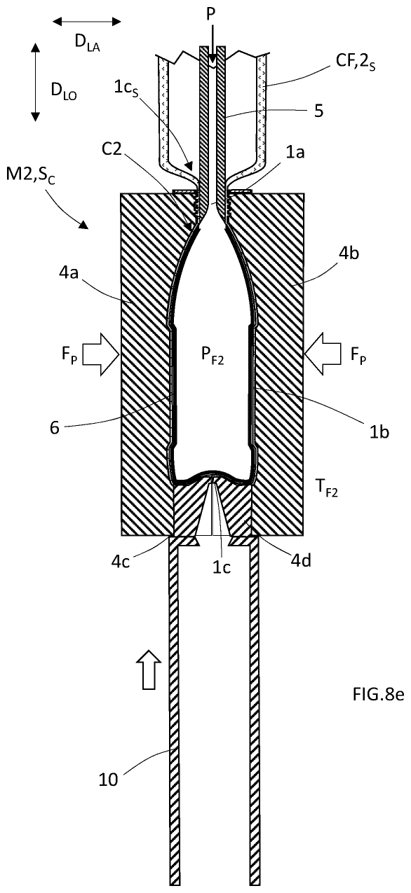

A further alternative embodiment of the product forming unit U is shown in FIGS. 8a-e. In this embodiment, the forming mould M2 has a configuration similar to the one described above for forming cellulose products 1 into bottles. The product forming unit U comprises a transporting device 10 that is feeding the formed semi-closed bottom portion 1c_{S} and the intermediate section S_{INT} into the forming mould M2. The transporting device 10 is engaging the semi-closed bottom portion 1c_{S} and pulling the formed semi-closed bottom portion 1c_{S} and the intermediate section S_{INT} into the forming mould M2 as understood from the figures.

In FIG. 8a, the forming mould M2 is arranged in the open state S_{O}, and in the open state S_{O} the transporting device 10 is moved into the forming mould for engaging the semi-closed bottom portion 1c_{S}. The transporting device 10 may be arranged with gripping members, such as hook-like edge segments or suction devices for efficiently engaging the semi-closed bottom portion 1c_{S}. When the transporting device 10 has engaged the semi-closed bottom portion 1c_{S}, the transporting device 10 is displaced for pulling the semi-closed bottom portion 1c_{S} and the intermediate section S_{INT} into the forming mould M2, as shown in FIG. 8b. When the transporting device 10 has pulled the semi-closed bottom portion 1c_{S} and the intermediate section S_{INT} into the correct position in forming mould M2, the transporting device 10 is removed from the forming mould Ms, as understood from FIG. 8c. Thereafter, the forming mould M2 is displaced in the lateral direction D_{LA} into a partly closed state S_{PC} shown in FIG. 8d, in which the transporting device 10 may be used for pushing the lower mould parts 4c,4d in the longitudinal direction D_{LO} into the closed state S_{C} of the forming mould M2 shown in FIG. 8e. In this way, the transporting device 10 thus may have a dual functionality for both transporting the formed semi-closed bottom portion 1c_{S} and the intermediate section S_{INT} into the forming mould M2 and for displacing the lower mould parts.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Cellulose product
1a: Neck portion
1a_{I}: Inner surface
1a_{O}: Flow opening
1a_{OU}: Outer surface
1a_{T}: Trailing neck portion
1b: Upper portion
1c: Closed bottom portion
1c_{C}: Collar section
1c_{L}: Lowest part
1c_{O}: Collar opening
1c_{S}: Semi-closed bottom portion
1d: Threaded section
1F: Following cellulose product
1L: Leading cellulose product
1P: Preceding cellulose product
1T: Trailing cellulose product
2: Cellulose blank structure
2a: Inner surface
2b: Outer surface
2c: Side edge
2_{S}: Shaped cellulose blank structure
3a: Outer mould part
3b: Inner mould part
3c: Thread forming section
4a: First upper mould part
4b: Second upper mould part
4c: First lower mould part
4d: Second lower mould part
5: Pressure lance
5a: First end
5b: Second end
6: Flexible membrane
7: Cutting device
8: Deflecting rollers
9: Auxiliary cutting device
10: Transporting device
A: Pivoting axis
CF: Cellulose fibres
CF_{CS}: Compressed fibre structure
C1,C2: Forming cavity
D: Fluid control device
D_{LA}: Lateral direction
D_{LO}: Longitudinal direction
F: Feeding unit
I_{FULL}: Fully inflated state
I_{PART}: Partly inflated state
M1: Pre-forming mould
M2: Forming mould
O: Overlapping tube-like configuration
P: Pressure medium
P_{F}: Forming pressure
S: Shaping unit
S1: First section
S2: Second section
S_{C}: Closed state
S_{INT}: Intermediate section
S_{O}: Open state
S_{PC}: Partly closed state
T: Transportation unit
T_{F}: Forming temperature
U: Product forming unit

1. A method for dry-forming a cellulose product from cellulose fibers in a product forming unit comprising a forming mold wherein the forming mold comprises upper mold parts and lower mold parts forming a forming cavity
wherein a flexible membrane connected to and arranged in fluid communication with a pressure lance is arranged in the forming cavity, wherein the method comprises the steps:
opening the forming mold and arranging cellulose fibers into the open forming mold
closing the forming mold around the cellulose fibers, wherein upon closing of the forming mold, the upper mold parts are moved towards each other in a lateral direction, and the lower mold parts are moved towards each other in the lateral direction and in a longitudinal direction towards the flexible membrane
inflating the flexible membrane with a pressure medium entering from the pressure lance and applying a forming pressure onto the cellulose fibers by pressing the cellulose fibers against the upper mold parts and lower mold parts by means of the inflated flexible membrane, and applying a forming temperature onto the cellulose fibers, for dry-forming the cellulose product with a three-dimensional compressed fiber structure having a closed bottom portion and an upper portion,
wherein the method further comprises the steps: partly inflating the flexible membrane with the pressure medium before movement or upon movement of the lower mold parts in the longitudinal direction towards the flexible membrane, wherein the partly inflated flexible membrane is pushing the cellulose fibers towards the lower mold parts and/or wherein the lower mold parts are pushing the cellulose fibers towards the partly inflated flexible membrane; and thereafter when the forming mold is closed around the cellulose fibers, fully inflating the flexible membrane with the pressure medium for applying the forming pressure onto the cellulose fibers.

2. The method according to claim 1,
wherein the lower mold parts are movably connected to the upper mold parts and configured for being displaced relative to the upper mold parts in the longitudinal direction.

3-5. (canceled)

6. The method according to claim 1,
wherein the method further comprises the steps: deflating the flexible membrane and opening the forming mold after forming of the cellulose product; wherein upon opening the forming mold, the upper mold parts are moved away from each other in the lateral direction, and the lower mold parts are moved away from each other in the lateral direction and in the longitudinal direction away from the flexible membrane.

7. The method according to claim 6,
wherein the lower mold parts are movably connected to the upper mold parts and configured for being displaced relative to the upper mold parts in the longitudinal direction, wherein the method further comprises the steps: moving the upper mold parts away from each other together with moving the lower mold parts away from each other in the lateral direction, and moving the lower mold parts relative to the upper mold parts in the longitudinal direction away from the flexible membrane upon opening of the forming mold.

8. The method according to claim 6,
wherein upon opening the forming mold, the lower mold parts are first moved in the longitudinal direction away from the flexible membrane and thereafter away from each other in the lateral direction; or wherein upon opening the forming mold, the lower mold parts are simultaneously moved away from each other in the lateral direction and in the longitudinal direction away from the flexible membrane.

9. The method according to claim 1,
wherein the method further comprises the steps: air-forming the cellulose fibers into a cellulose blank structure and shaping the air-formed cellulose blank structure into a shaped cellulose blank structure having a tube-like configuration upstream the forming mold,
wherein when arranging the cellulose fibers into the open forming mold, the shaped cellulose blank structure is fed around the pressure lance and flexible membrane into the forming mold in the longitudinal direction, wherein the feeding of the shaped cellulose blank structure is stopped when positioned in the open forming mold.

10. The method according to claim 9,
wherein the dry-formed cellulose product comprises a neck portion, wherein the upper portion is arranged between the closed bottom portion and the neck portion wherein the upper portion is arranged in fluid communication with the neck portion wherein the method further comprises the steps:
feeding a first section of the shaped cellulose blank structure to a pre-forming mold upstream the forming mold and forming a semi-closed bottom portion of the cellulose product from the first section in the pre-forming mold, simultaneously with forming the neck portion of a directly preceding cellulose product from the first section in the pre-forming mold;
feeding a following second section of the shaped cellulose blank structure to the pre-forming mold and forming the neck portion of the cellulose product from the second section in the pre-forming mold, simultaneously with forming a semi-closed bottom portion of a directly following cellulose product from the second section in the pre-forming mold.

11. The method according to claim 10,
wherein the pre-forming mold comprises openable and closable mold parts arranged around the pressure lance, wherein a forming cavity is formed between the mold parts and the pressure lance, wherein the forming of the semi-closed bottom portion of the cellulose product in the pre-forming mold further comprises the steps: opening the mold parts;
feeding the shaped cellulose blank structure around the pressure lance and through the mold parts;
stopping the feeding of the shaped cellulose blank structure when the first section of the shaped cellulose blank structure is arranged in a position aligned with the mold parts;
closing the mold parts and pressing the first section against the pressure lance by means of the mold parts for forming the semi-closed bottom portion of the cellulose product in the forming cavity and simultaneously forming the neck portion of the directly preceding cellulose product in the forming cavity.

12. The method according to claim 11,
wherein the forming of the neck portion of the cellulose product in the pre-forming mold further comprises the steps: opening the mold parts;
feeding the shaped cellulose blank structure around the pressure lance and through the mold parts;
stopping the feeding of the shaped cellulose blank structure when the second section of the shaped cellulose blank structure is arranged in a position aligned with the mold parts;
closing the mold parts and pressing the second section against the pressure lance by means of the mold parts for forming the neck portion of the cellulose product in the forming cavity, and simultaneously forming the semi-closed bottom portion of the directly following cellulose product in the forming cavity.

13. (canceled)

14. The method according to claim 10,
wherein the method further comprises the steps: feeding the formed semi-closed bottom portion of the cellulose product and an intermediate section of the shaped cellulose blank structure between the formed semi-closed bottom portion of the cellulose product and the formed neck portion of the cellulose product to the forming mold;
forming the upper portion of the cellulose product from the intermediate section and forming the closed bottom portion of the cellulose product from the semi-closed bottom portion in the forming mold.

15-16. (canceled)

17. The method according to claim 10,
wherein the product forming unit further comprises a cutting device arranged in the upper mold parts of the forming mold or in connection to the upper mold parts of the forming mold, wherein the method further comprises the step: cutting off the formed neck portion of the cellulose product from the semi-closed bottom portion of the directly following cellulose product by means of the cutting device during the forming of the cellulose product in the forming mold.

18. The method according to claim 10,
wherein the pre-forming mold comprises a thread forming section, wherein the method further comprises the step: forming a threaded section of the neck portion upon forming of the neck portion in the pre-forming mold by means of the thread forming section.

19. A product forming unit for dry-forming a cellulose product from cellulose fibers, wherein the product forming unit comprises a forming mold having upper mold parts and lower mold parts forming a forming cavity wherein a flexible membrane connected to and arranged in fluid communication with a pressure lance is arranged in the forming cavity,
wherein the forming mold is configured for being closed around the cellulose fibers, wherein upon closing of the forming mold, the upper mold parts are moved towards each other in a lateral direction, and the lower mold parts are moved towards each other in the lateral direction and in a longitudinal direction towards the flexible membrane,
wherein the flexible membrane is configured for being inflated with a pressure medium entering from the pressure lance for applying a forming pressure onto the cellulose fibers by pressing the cellulose fibers against the upper mold parts and lower mold parts by means of the inflated flexible membrane and the forming mold is configured for applying a forming temperature onto the cellulose fibers, for dry-forming the cellulose product with a three-dimensional compressed fiber structure having a closed bottom portion and an upper portion,
wherein the product forming unit is configured for partly inflating the flexible membrane with the pressure medium before movement or upon movement of the lower mold parts in the longitudinal direction towards the flexible membrane, wherein the partly inflated flexible membrane is configured for pushing the cellulose fibers towards the lower mold parts and/or wherein the lower mold parts are configured for pushing the cellulose fibers towards the partly inflated flexible membrane.

20. The product forming unit according to claim 19,
wherein the lower mold parts are movably connected to the upper mold parts and configured for being displaced relative to the upper mold parts in the longitudinal direction.

21. (canceled)

22. The product forming unit according to claim 19,
wherein the forming mold is configured for being opened after forming of the cellulose product wherein upon opening the forming mold, the upper mold parts are moved away from each other in the lateral direction, and the lower mold parts are moved away from each other in the lateral direction and in the longitudinal direction away from the flexible membrane.

23. The product forming unit according to claim 19,
wherein the pressure lance is extending to or partly into the forming cavity.

24. The product forming unit according to claim 19,
wherein the product forming unit comprises a shaping unit and a feeding unit, wherein the shaping unit is configured for shaping a cellulose blank structure air-formed from the cellulose fibers into a shaped cellulose blank structure having a tube-like configuration upstream the forming mold, wherein the feeding unit is configured for feeding the shaped cellulose blank structure in the longitudinal direction around the pressure lance and flexible membrane into the forming mold when arranging the cellulose fibers into the open forming mold.

25. The product forming unit according to claim 19,
wherein the product forming unit is configured for dry-forming the cellulose product from the air-formed cellulose blank structure, wherein the dry-formed cellulose product comprises a neck portion, wherein the upper portion is arranged between the closed bottom portion and the neck portion, wherein the upper portion is arranged in fluid communication with the neck portion,
wherein the feeding unit is configured for feeding the shaped cellulose blank structure to a pre-forming mold upstream the forming mold, wherein the pre-forming mold is configured for forming a neck portion of a leading cellulose product simultaneously with forming a semi-closed bottom portion of a directly following trailing cellulose product from the shaped cellulose blank structure.

26. The product forming unit according to claim 25,
wherein the pre-forming mold comprises openable and closable mold parts arranged around the pressure lance, wherein a forming cavity is formed between the mold parts and the pressure lance, wherein the feeding unit is configured for feeding the shaped cellulose blank structure around the pressure lance and through the mold parts when the mold parts are open, wherein the mold parts when closed are configured for pressing the shaped cellulose blank structure against the pressure lance for simultaneously forming the neck portion and the semi-closed bottom portion in the forming cavity, wherein the mold parts of the pre-forming mold comprises a thread forming section configured for forming a threaded section of the neck portion upon forming of the neck portion in the pre-forming mold.

27. (canceled)

28. The product forming unit according to claim 24,
wherein the feeding unit is configured for feeding a formed semi-closed bottom portion and an intermediate section of the shaped cellulose blank structure between the formed semi-closed bottom portion and a directly following formed trailing neck portion to the forming mold, wherein the forming mold is configured for forming the upper portion from the intermediate section and forming the closed bottom portion from the semi-closed bottom portion,
wherein the product forming unit further comprises a cutting device arranged in the upper mold parts or in connection to the upper mold parts, wherein the cutting device is configured for cutting off the formed neck portion of a leading cellulose product from the semi-closed bottom portion of a directly following trailing cellulose product by means of the cutting device during the forming of the cellulose product in the forming mold, wherein the product forming unit comprises a fluid control device, wherein the pressure lance at a first end is arranged in fluid communication with the fluid control device, and wherein the pressure lance at a second end is arranged in fluid communication with the flexible membrane, wherein the fluid control device is configured for inflating the flexible membrane with the pressure medium via the pressure lance.

29-31. (canceled)
